(19) United States
(12) Patent Application Publication
(10) Pub. No.: US 2026/0163724 A1
(43) Pub. Date: Jun. 11, 2026

(54) LOGIC CIRCUITRY COMMUNICATION CHANNELS

(71) Applicant: HEWLETT-PACKARD DEVELOPMENT COMPANY, L.P., Spring, TX (US)

(72) Inventors: Stephen D. Panshin, Corvallis, OR (US); Jefferson P. Ward, Vancouver, WA (US); Kyle L. Michel, Vancouver, WA (US); Michael Peeters, Tourinnes-la-Grosse (BE)

(73) Assignee: HEWLETT-PACKARD DEVELOPMENT COMPANY, L.P., Spring, TX (US)

(21) Appl. No.: 19/181,294

(22) Filed: Apr. 16, 2025

Related U.S. Application Data
(63) Continuation of application No. PCT/US2023/027421, filed on Jul. 11, 2023.

(51) Int. Cl. H04L 9/08

(52) U.S. Cl. CPC H04L 9/085; H04L 9/0894

(57) ABSTRACT

A logic circuit includes an interface to communicate with a host, a processor, and a memory. The memory stores instructions that when executed by the processor cause the processor to, in response to a first start session command without having previously derived a shared key with the host, communicate with the host through a pairing channel where communications are authenticated using a session key derived from a pairing base key, to derive the shared key. The memory stores further instructions that when executed by the processor cause the processor to, in response to the first start session command and after having derived the shared key, communicate with the host through a nominal channel where communications are authenticated using a session key derived from the shared key.

### CROSS-REFERENCE TO RELATED APPLICATIONS

The present application is a bypass continuation of International Patent Application No. PCT/US2023/027421, filed Jul. 11, 2023, which is incorporated herein by reference in its entirety.

### BACKGROUND

Network or system components may communicate with one another in a number of ways. For example, Serial Peripheral Interface (SPI) protocol, Bluetooth Low Energy (BLE), Near Field Communications (NFC) or other types of digital or analog communications may be used.

Some two-dimensional (2D) and three-dimensional (3D) printing systems include one or more replaceable print apparatus components, such as print material containers (e.g., inkjet cartridges, toner cartridges, ink supplies, 3D printing agent supplies, build material supplies, etc.), inkjet printhead assemblies, and the like. In some examples, logic circuitry associated with the replaceable print apparatus component(s) communicates with logic circuitry of the print apparatus in which they are installed, for example communicating information such as their identity, capabilities, status, and the like. Similarly, other communication systems use logic circuits to connect to a host logic circuit, of which general examples include network communication systems, life science applications, automotive industry, the internet of things, etc.

Many instances of logic circuitry include at least one authentication function for secure communication. In some instances, the authentication function can be compromised after attempts to attack and/or hack the logic circuitry by unauthorized third parties.

### BRIEF DESCRIPTION OF THE DRAWINGS

FIG. 1 illustrates one example of a printing system.

FIG. 2 illustrates one example of a replaceable print apparatus component.

FIG. 3 illustrates one example of a print apparatus.

FIG. 4 illustrates one example of a replaceable print cartridge.

FIGS. 5A and 5B illustrate example memory arrangements.

FIGS. 6A and 6B illustrate example logic circuits.

FIG. 7A is a flow diagram illustrating one example of implementing a pairing session between a first logic circuit and a second logic circuit.

FIG. 7B is a flow diagram illustrating one example of implementing a nominal session between a first logic circuit and a second logic circuit.

FIGS. 8A-8O are flow diagrams illustrating example methods that may be carried out by a logic circuit.

FIGS. 9A-9D are block diagrams illustrating one example of a processing system for pairing a logic circuitry package.

FIG. 10 illustrates another example of a logic circuit.

FIG. 11 is a flow diagram illustrating one example of implementing an admin session for a first logic circuit.

FIG. 12 is a flow diagram illustrating one example of implementing a legacy session between a first logic circuit and a second logic circuit.

FIGS. 13A-13C are block diagrams illustrating one example of a processing system for communicating with a host through channels.

FIGS. 14A and 14B illustrate other example memory arrangements.

FIGS. 15A-15E are flow diagrams illustrating other example methods that may be carried out by a logic circuit.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that each individual feature or combination of features of the various examples described herein may be combined, in part or whole, with each other individual feature or combination of features.

Some examples of applications described herein are in the context of print apparatus. Not all the examples, however, are limited to such applications, and at least some of the principles set out herein may be used in other contexts.

Certain non-authorized third parties attempt to reverse engineer parts of Original Equipment Manufacturers (OEMs) or otherwise authorized parties to connect to apparatuses of OEMs or otherwise authorized parties. Authorized parties include parties in the authorized chain that may include OEMs, suppliers, developers, etc., for example authorized by intellectual property rights or otherwise associated with these parts and apparatus, while non-authorized third parties may be third parties that try to at least partially copy or emulate the original logic circuits of these authorized parties to connect to the host apparatus of these authorized parties, without any pre-authorized relation with the authorized parties.

In one practical example, logic circuits may include microcontrollers attached, or configured to be attached, to print consumable cartridges, where the host print apparatus logic circuits may include printer controllers and/or printer microcontrollers. In this disclosure, the host logic circuit may be any host side microcontroller, controller, application specific integrated circuit (ASIC), or the like. The host logic circuit may sometimes be referred to, simply, as “host”, while a “logic circuit” by itself should refer to the component-side logic circuit, not the host. For example, in I2C terminology, the host logic circuit may be a controller/master, while the component logic circuit may be a peripheral/slave. Furthermore, certain examples set out in this disclosure may be applied to any two opposite communicating devices without any hierarchical implication, for example, without needing a host (or controller) versus component (or peripheral) relationship. Hence, throughout this disclosure, “host” may be replaced by “controller”. A controller may comprise a system component, host, supply device, computer, printer, etc. The host or controller may comprise an opposite microcontroller and/or firmware that communicates with a logic circuit of this disclosure. In a host print apparatus, the host print apparatus logic circuit may command a logic circuit of a replaceable print supply component. In certain examples of this disclosure, the logic circuit is configured to command the opposite controller or host, such as in a pairing session.

In some instances, authentication solutions may use symmetric cryptography where base keys are repeatedly used in logic circuits of print consumable cartridges to derive session keys used to validate commands and/or generate responses. Such repeated use of the base keys allows an attacker more opportunities to attack the keys. Authentication solutions using symmetric cryptography may use master keys (or other parent keys) in the host. This allows an attacker the opportunity to recover more valuable keys than the keys in the print consumable cartridges. In other instances, authentication solutions may use asymmetric cryptography, which may repeatedly use private keys in the print consumable cartridges to generate responses. Such repeated use of the private keys allows an attacker more opportunities to attack the keys. Asymmetric keys are more susceptible to both physical and side-channel attacks than symmetric keys.

In logic circuits of print consumable cartridges having multiple authentication features, the logic circuits may accept any challenge in any order, making all the authentication features vulnerable to simultaneous attack (i.e., enabling an attacker to work on reverse-engineering all the authentication features in parallel). In addition, the number of commands required to execute a complete authentication sequence may require a considerable amount of time, which may affect system responsiveness. In logic circuits of print consumable cartridges that support any authentication features, the logic circuits may accept more challenges originating from the same host print apparatus than are required for normal operation (i.e., enabling an attacker to have repeated access to the authentication features to study how they work). In logic circuits of print consumable cartridges designed for use with a host print apparatus that supports authentication, the host is the authenticator and is allowed to determine how the authentication should be performed. Therefore, the host is allowed to issue challenges at will. This ability to issue challenges at will, however, presents opportunities for attackers including the ability to extract valuable information from the host firmware (e.g., command codes, command parameters, etc. and how to parse/evaluate responses) and/or if host firmware can be spoofed, then the attacker can control the requested authentication. Further, in logic circuits of print consumable cartridges that over their lifetimes support many authenticated sessions with host print apparatus, corresponding key material and secret algorithms that support the many authenticated sessions is needed, thereby making the key(s) and secret algorithms more vulnerable to attack. Furthermore, logic circuits may be accessed, personalized, adapted, etc. by different types of hosts at different stages. For different host types and different types of interaction, different security levels/features may be desired.

While certain example logic circuitry packages of this disclosure may increase a cost or difficulty of successfully hacking, copying, and/or emulating the logic circuitry package, it is not excluded that certain versions of this logic circuitry package may still be constructed by third parties on the long term, as a result of reverse engineering, thin film decapsulation, hacking, copying, and/or emulating. Correspondingly, examples of logic circuitry packages in this disclosure are configured to overcome predesigned challenges of the host controller to be able to operate with that host controller, while the security or anti-hacking advantages, if any, may be secondary.

As said, logic circuitry packages may be associated with print apparatus components such as cartridges or containers, and host logic circuits may be associated with host print apparatus to which the components are to be connected. In other examples, logic circuits do not need to be associated with print components or host print apparatus. Logic circuits can be used in conjunction with any Micro-Electrical Mechanical System, Lab-on-Chip, mobile computing device, and/or Life Science application. A wide range of applications require a logic circuitry package such as a microcontroller to securely connect to a host, physically and/or communicatively. The logic circuitry packages may connect to any type of host, for example any computing system, server, car system, apparatus for domestic use, access control systems, etc. While many examples of this disclosure involve logic circuitry packages and logic circuits for print apparatus components to connect to a host print apparatus logic circuit, the features of logic circuitry packages can be applied outside of the field of printing, by itself or in association with any component, to connect to any type of host logic circuit, not necessarily associated with a print apparatus component or print apparatus, respectively. Hence, where this disclosure refers to a print apparatus and print apparatus component (or cartridge or container), or the like, the apparatus can be any apparatus and the component can be any component. Examples of this disclosure allow for a host logic circuit to securely identify and authenticate a logic circuit associated with a host, and some examples of this disclosure may allow for the logic circuit to securely identify and/or authenticate the host.

In certain examples, Inter-integrated Circuit (I²C, or I2C, which notation is adopted herein) protocol allows at least one ‘leader’ (commonly referred to as a ‘master’) integrated circuit (IC) to communicate with at least one ‘follower’ (commonly referred to as a ‘slave’) IC, for example via a bus. I2C, and other communications protocols, communicate data according to a clock period. For example, a voltage signal may be generated, where the level of the voltage is associated with data. For example, a voltage level above X volts may indicate a logic “1” whereas a voltage level below X volts may indicate a logic “0”, where X is a predetermined numerical value. By generating an appropriate voltage in each of a series of clock periods, data can be communicated via a bus or another communication link. Certain examples of this disclosure concern follower or slave logic. In other examples, there need not be a master-slave or leader-follower or host-component relationship, whereby both oppositely communicating logic circuits (e.g., microcontrollers) can receive commands and respond to commands.

In at least some examples, a plurality of logic circuitry packages (each of which may be associated with a different replaceable print apparatus component or container) may be connected to an I2C bus. Certain example print material containers have follower logic that utilize I2C communications, although in other examples, other forms of digital or analog communications could also be used. In the example of I2C communication, a leader IC may generally be provided as part of the print apparatus (which may be referred to as the ‘host’) and a replaceable print apparatus component would comprise a ‘follower’ IC, although this need not be the case in all examples. There may be a plurality of follower ICs connected to an I2C communication link or bus (for example, containers of different colors of print agent). An address of the logic circuitry package may be an I2C compatible address (herein after, an I2C address), for example in accordance with an I2C protocol, to facilitate directing communications between leader to followers in accordance with the I2C protocol. The follower IC(s) may include a processor to perform data operations before responding to requests from logic circuitry of the print system. In certain examples, the follower IC, or logic circuitry package, of this disclosure may be connected to or integrated with any print apparatus component that can be or is connected to or integrated with a print apparatus. For example, the logic circuitry package or follower IC of this disclosure may be connected to a non-replaceable print apparatus component. In other examples, other forms of digital and/or analog communication can be used, other than I2C.

Communications between print apparatus and replaceable print apparatus components installed in the apparatus (and/or the respective logic circuitry thereof) may facilitate various functions. Logic circuitry within a print apparatus may receive information from logic circuitry associated with a replaceable print apparatus component via a communications interface, and/or may send commands to the replaceable print apparatus component logic circuitry, which may include commands to write data to a memory associated therewith, or to read data therefrom.

In at least some of the examples described below, a logic circuitry package is described. The logic circuitry package may be associated with a replaceable print apparatus component, for example being internally or externally affixed thereto, for example at least partially within the housing, and is adapted to communicate data with a print apparatus controller via a bus provided as part of the print apparatus.

A ‘logic circuitry package’ as the term is used herein refers to one logic circuit, or more logic circuits that may be interconnected or communicatively linked to each other. Where more than one logic circuit is provided, these may be encapsulated as a single unit, or may be separately encapsulated, or not encapsulated, or some combination thereof. The package may be arranged or provided on a single substrate or a plurality of substrates. In some examples, the package may be directly affixed to a cartridge wall. In some examples, the package may include an interface, for example including pads or pins. The package interface may be intended to connect to a communication interface of the print apparatus component that in turn connects to a print apparatus logic circuit, or the package interface may connect directly to the print apparatus logic circuit. Example packages may be configured to communicate via a serial bus interface. Where more than one logic circuit is provided, these logic circuits may be connected to each other or to the interface, to communicate through the same interface.

In some examples, each logic circuitry package is provided with at least one processor and memory. In one example, the logic circuitry package may be, or may function as, a microcontroller or secure microcontroller. In use, the logic circuitry package may be adhered to or integrated with the replaceable print apparatus component, such as a replaceable print consumable (e.g., ink, toner) cartridge. A logic circuitry package may alternatively be referred to as a logic circuitry assembly, or simply as logic circuitry or processing circuitry.

In certain examples of this disclosure, a package refers to the result of the final assembly of the logic circuit or integrated circuit assembly process, that is, basically the final form of the processing circuitry hardware itself (disregarding certain customization- or personalization- or writing steps that may occur afterwards and/or the further attachment or connection to another component or circuit). In a relatively dressed down form, the package may be a substrate with thin film layers without further protection such as encapsulation. In other examples, the package may comprise a circuit that is at least partially protected by encapsulation or molded material, and/or supported by a board (e.g., PCB) and/or flexible film and/or a molded plastic part, for example of a print cartridge. In certain instances, the logic circuit is substantially surrounded by protective and/or insulative material except for electrodes that are to connect the logic circuit to a host and/or other logic circuit. All these instances, and others, may refer to a package.

In some examples, the logic circuitry package may respond to various types of requests (or commands) from a host (e.g., a print apparatus) logic circuit. One type of request may include a request for data, for example identification information, print material volume, print material level, print material color, printed page count, authentication information, etc., for example stored in and/or updated (e.g., written) to a general use memory portion. Another type of request may be a request for a data processing action (e.g., pairing command generation, session key generation). There may be additional types of requests. In this disclosure, a command is also a type of request. In certain passages of this disclosure the terms request and command are used interchangeably, that is, mean the same thing.

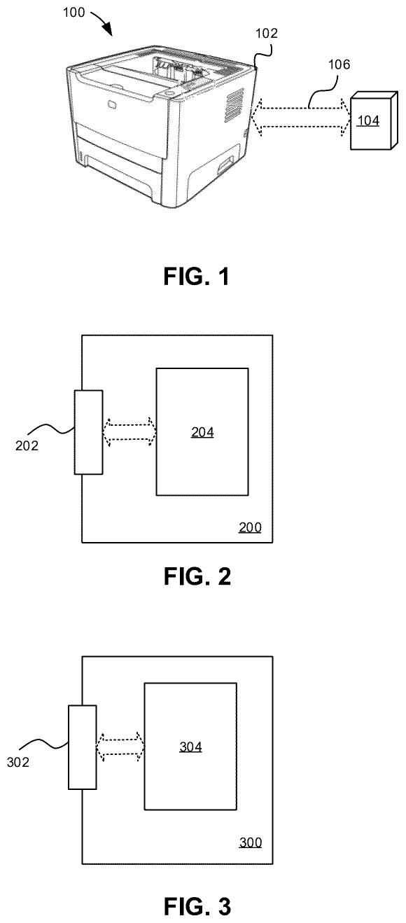

FIG. 1 illustrates one example of a printing system 100. The printing system 100 includes a print apparatus 102 in communication with logic circuitry associated with a replaceable print apparatus component 104 via a communications link 106. In some examples, the communications link 106 may include an I2C capable or compatible bus (herein after, an I2C bus). Although for clarity, the replaceable print apparatus component 104 is shown as external to the print apparatus 102, in some examples, the replaceable print apparatus component 104 may be housed within the print apparatus.

The replaceable print apparatus component 104 may include, for example, a print material container or cartridge (which could be a build material container for 3D printing, a liquid or dry toner container for 2D printing, or an ink or liquid print agent container for 2D or 3D printing), which may in some examples include a print head or other dispensing or transfer component. The print material may be a consumable print material to be consumed by dispensing or transferring. In this disclosure, a print material, print consumable, or consumable print material may be the same thing, examples of which are indicated between parentheses above. The replaceable print apparatus component 104 may, for example, contain a consumable resource of the print apparatus 102, or a component which is likely to have a lifespan which is less (in some examples, considerably less) than that of the print apparatus 102. Moreover, while a single replaceable print apparatus component 104 is shown in this example, in other examples, there may be a plurality of replaceable print apparatus components, for example including print agent containers of different colors, print heads (which may be integral to the containers), or the like. In other examples, the print apparatus components 104 could include service components, for example to be replaced by service personnel, examples of which could include print heads, toner process cartridges, or logic circuitry packages by themselves to adhere to corresponding print apparatus components and communicate to a compatible print apparatus logic circuit.

FIG. 2 illustrates one example of a replaceable print apparatus component 200, which may provide the replaceable print apparatus component 104 of FIG. 1. The replaceable print apparatus component 200 includes a data interface 202 and a logic circuitry package 204. In use of the replaceable print apparatus component 200, the logic circuitry package 204 decodes data received via the data interface 202. The logic circuitry may perform other functions as set out below. The data interface 202 may include an I2C or other interface. In certain examples, the data interface 202 may be part of the same package as the logic circuitry package 204.

In some examples, the logic circuitry package 204 may be further configured to encode data for transmission via the data interface 202. In some examples, there may be more than one data interface 202 provided. In some examples, the logic circuitry package 204 may be arranged to act as a ‘follower’ in I2C communications.

FIG. 3 illustrates one example of a print apparatus 300. The print apparatus 300 may provide the print apparatus 102 of FIG. 1. The print apparatus 300 may serve as a host for replaceable components. The print apparatus 300 includes an interface 302 for communicating with a replaceable print apparatus component and a print apparatus logic circuit 304, such as a controller. In some examples, the interface 302 is an I2C interface.

In some examples, the print apparatus logic circuit 304 may be configured to act as a host, or a leader, in I2C communications. The print apparatus logic circuit 304 may generate and send commands to at least one replaceable print apparatus component 200, and may receive and decode responses received therefrom. In other examples, the print apparatus logic circuit 304 may communicate with the logic circuitry package 204 using any form of digital or analog communication.

The print apparatus 102, 300 and replaceable print apparatus component 104, 200, and/or the logic circuitry thereof, may be manufactured and/or sold separately. In an example, a user may acquire a print apparatus 102, 300 and retain the apparatus 102, 300 for a number of years, whereas a plurality of replaceable print apparatus components 104, 200 may be purchased in those years, for example as print agent is used in creating a printed output. Therefore, there may be at least a degree of forwards and/or backwards compatibility between print apparatus 102, 300 and replaceable print apparatus components 104, 200

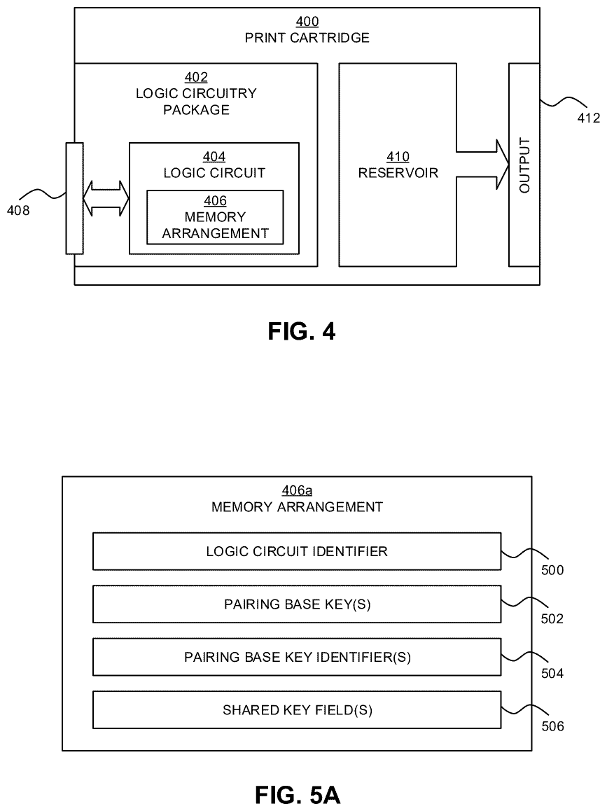

FIG. 4 illustrates one example of a replaceable print cartridge 400, such as a print consumable cartridge. Print cartridge 400 may provide the replaceable print apparatus component 104 of FIG. 1 or the replaceable print apparatus component 200 of FIG. 2. Print cartridge 400 includes a logic circuitry package 402 including a logic circuit 404 and an interface 408. In some examples, the interface 408 is an I2C interface. Logic circuit 404 includes a memory arrangement 406. In addition, print cartridge 400 includes a reservoir 410 to hold consumable material and an output 412 to dispense the consumable material. The consumable material may include ink, dry toner, liquid toner, a 3D print agent (e.g., a print enhancement agent, a print inhibiting agent, a build powder, such as a plastic powder or a metal powder), or another suitable consumable outside of the field of printing.

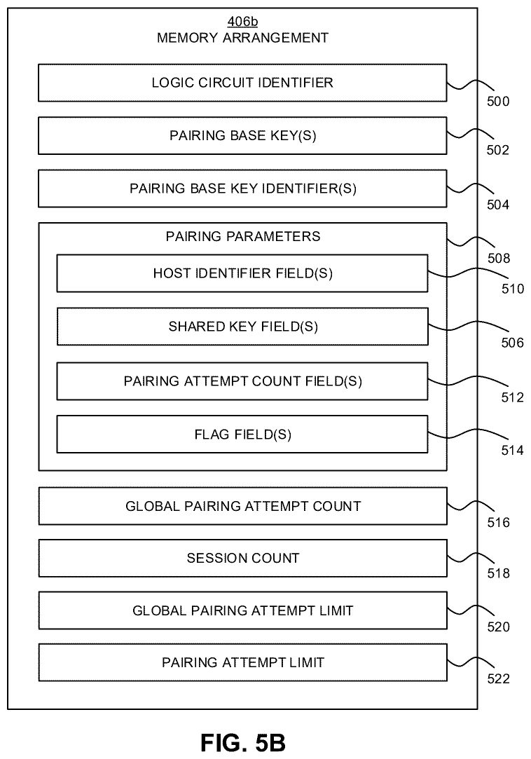

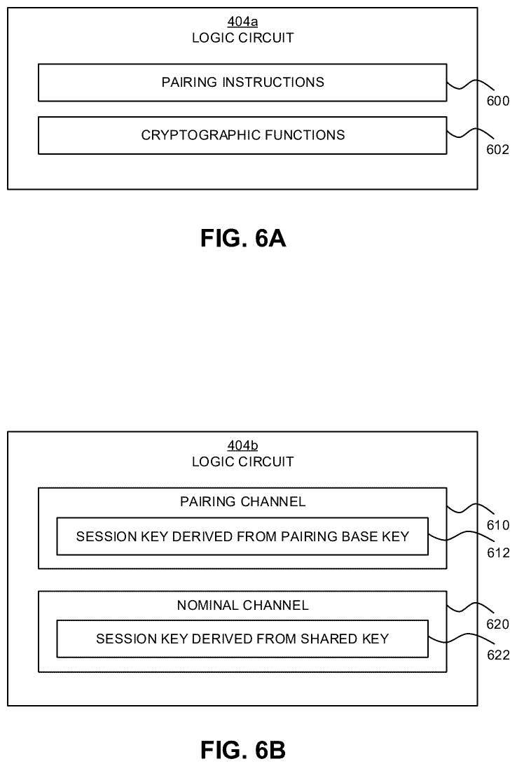

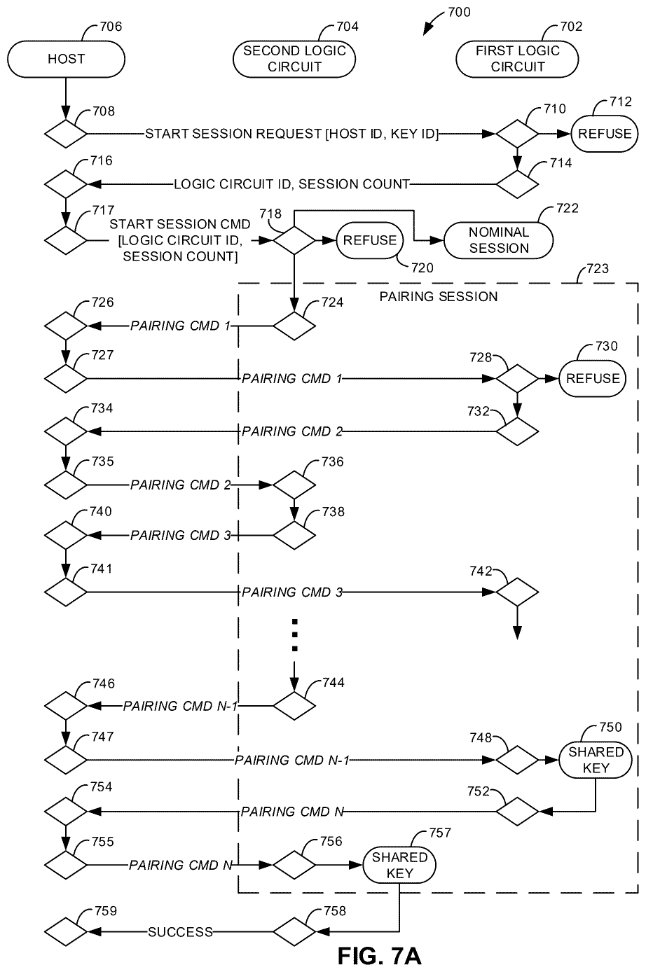

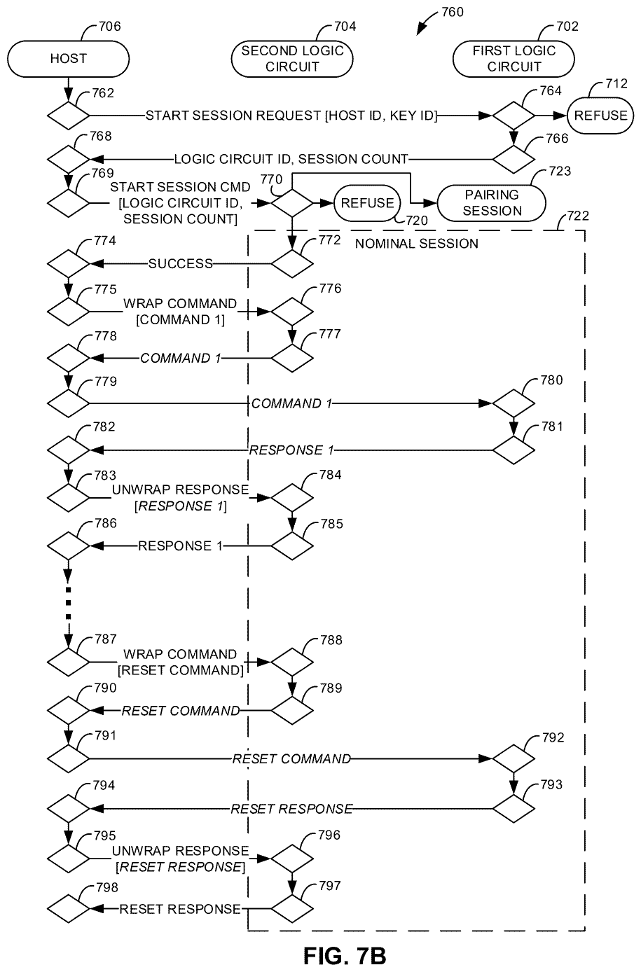

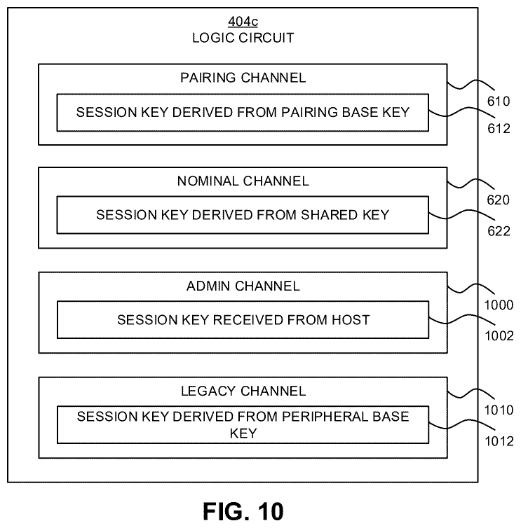

The logic circuitry package 402 may be associated with, or in some examples affixed to and/or be incorporated at least partially within the replaceable print cartridge 400. Logic circuit 404 is communicatively coupled to memory arrangement 406. Memory arrangement 406 may include a single or multiple memory devices, and may include any or any combination of volatile memory (e.g., Dynamic Random Access Memory (DRAM), Static Random Access Memory (SRAM), registers, etc.) and non-volatile memory (e.g., Read Only Memory (ROM), Electrically Erasable Programmable Read Only Memory (EEPROM), Flash, Erasable Programmable Read Only Memory (EPROM), memristor, etc.). In some examples, as described in more detail below with reference to FIGS. 5A-6B, memory arrangement 406 stores data used by the logic circuit 404 to execute pairing instructions (e.g., 600 of FIG. 6A) and cryptographic functions (e.g., 602 of FIG. 6A). In other examples, memory arrangement 406 stores data used by the logic circuit 404 to implement a pairing channel (e.g., 610 of FIG. 6B) and/or a nominal channel (e.g., 620 of FIG. 6B). Logic circuit 404 as described in more detail below with reference to FIG. 7A, may be configured to implement a pairing sequence with a host print apparatus logic circuit to verify the authenticity of the logic circuit 404. If the logic circuit 404 is verified to be authentic during the pairing sequence, the replaceable print cartridge 400 may be used by the host print apparatus. In other examples, memory arrangement 406 stores data used by the logic circuit 404 to implement an admin channel (e.g., 1000 of FIG. 10) and/or a legacy channel (e.g., 1010 of FIG. 10).

As described in more detail below, a pairing session (e.g., 723 of FIG. 7A) refers to an active cryptographic session, using a session key derived from a (e.g., specified) pairing base key. A pairing sequence refers to a specific sequence of commands (e.g., PAIRING CMD 1 through PAIRING CMD N of FIG. 7A) that is exchanged during a pairing session to derive a shared key. The pairing channel, the nominal channel, the admin channel, and the legacy channel specify different means of determining the host type/instance, the use of corresponding host-specific means of authentication, and/or the enforcement of the appropriate access to specific commands, command functionalities, attributes, etc. Different channels can be adapted to different types of hosts and/or interactions.

A pairing session may be implemented within the pairing channel but not within the nominal channel, the admin channel, or the legacy channel. A nominal session (e.g., 722 of FIG. 7B), that may amongst others be used for communication of general use data (e.g., print material level, color data, etc.), may be started after successful completion of the pairing sequence to derive the shared key. A nominal session refers to an active, for example cryptographically authenticated, communication session, using a session key derived from the shared key. A nominal session may be implemented within the nominal channel but not within the pairing channel, the admin channel, or the legacy channel. In one example, nominal sessions may occur after start-up of a host print apparatus and during printing, for example between print jobs, that is, before and/or after completing a print job.

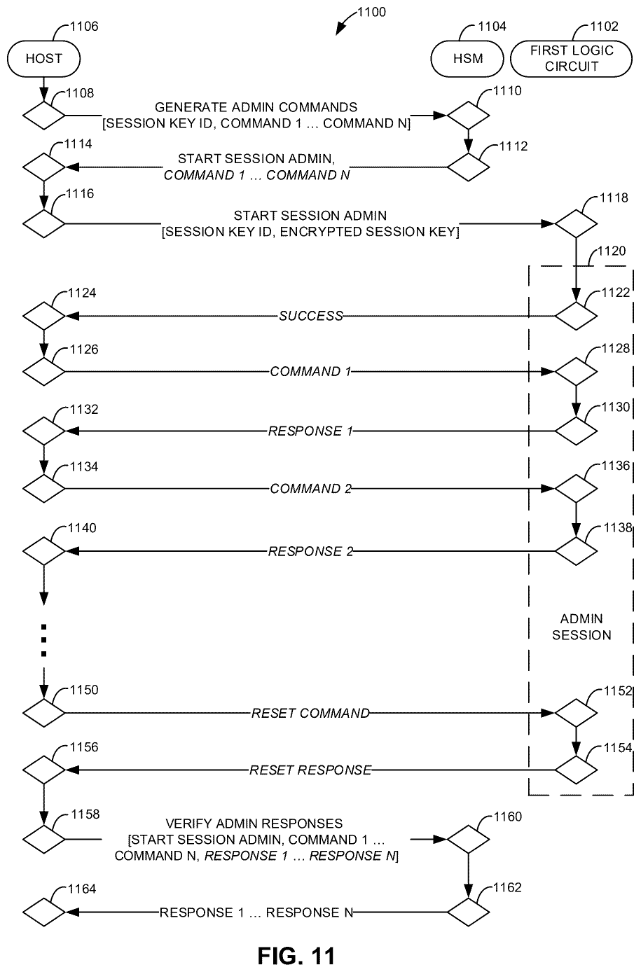

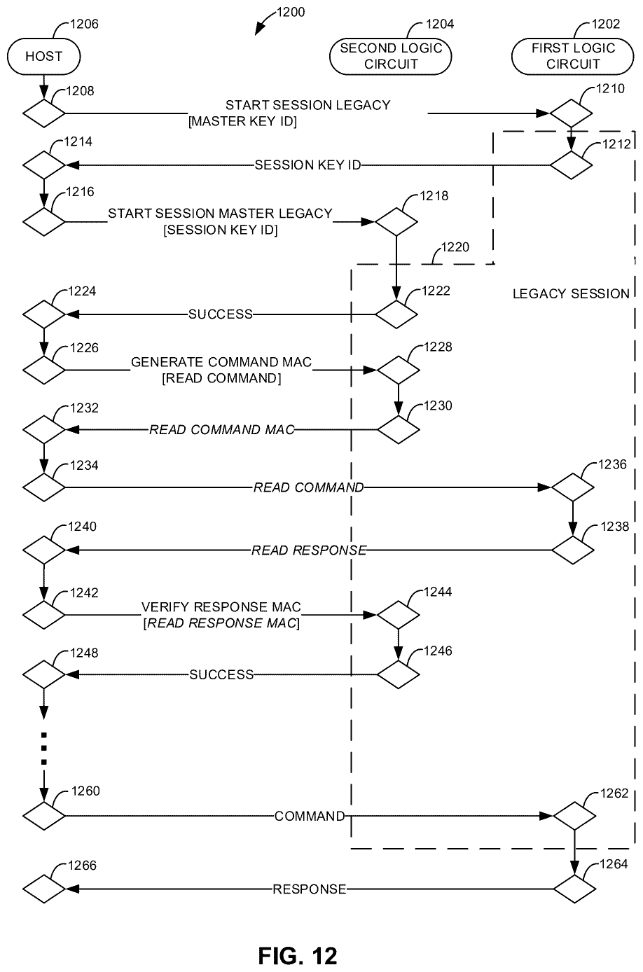

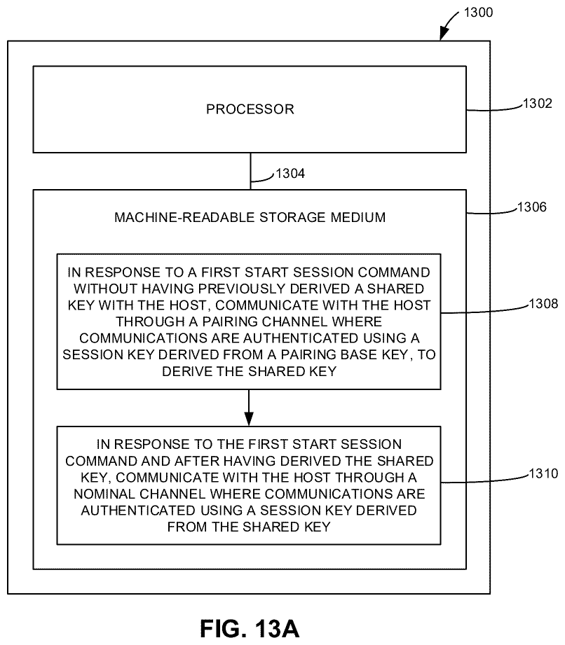

An admin session (e.g., 1120 of FIG. 11) may be implemented within the admin channel, but not within the pairing channel, the nominal channel, or the legacy channel. An admin session, which refers to an active, for example cryptographically authenticated, communication session, using a session key received from a host may be used to personalize the logic circuit 404 (e.g., to write keys, attributes, digital signatures, etc. to the memory arrangement 406). A legacy session (e.g., 1220 of FIG. 12) may be implemented within the legacy channel, but not within the pairing channel, the nominal channel, or the admin channel. A legacy session, which refers to an active, for example cryptographically authenticated, communication session, using a session key derived from a peripheral base key may be used to access the logic circuit 404 by a limited access processing system (e.g., a manufacturing system).

The example logic circuits disclosed herein may implement pairing sequences that enforce the order of received authentication commands to force an attacker to reverse engineer all the authentication features in order. The logic circuits are aware of the printing devices in which they are installed, the conditions under which pairing is initiated, and enforce appropriate limitations to reduce exposure of the authentication features to attacks. The logic circuits respond to each received pairing command with an active response which includes a pairing command to be delivered to the printing device, enforcing the overall order of the authentication sequence. In this way, valuable information is kept out of the host firmware (where it could be discovered) and an attacker (who may spoof host firmware) cannot control and/or modify the desired authentication sequence. The active responses of the logic circuits minimize the number of interactions required between the host (706) and the second logic circuit (704). The logic circuits may use an OEM provisioned pairing key during a pairing sequence, during which a shared key is negotiated (e.g., derived). This shared key may then be used for all subsequent authenticated sessions in the nominal channel. In this way, the exposure of the OEM provisioned pairing key is reduced, and the value to an attacker of the negotiated shared key (which would not be useful to produce a generic compatible logic circuit) is also reduced.

FIG. 5A illustrates one example of a memory arrangement 406a. In some examples, memory arrangement 406a may provide memory arrangement 406 of FIG. 4. Memory arrangement 406a stores a logic circuit identifier 500, pairing base key(s) 502 (e.g., a single pairing base key or multiple pairing base keys), pairing base key identifier(s) 504 (e.g., a single pairing base key identifier or multiple pairing base key identifiers) corresponding to respective pairing base key(s) 502, and shared key field(s) 506 (e.g., a single shared key field or multiple shared key fields) to store at least one to be generated shared key.

The logic circuit identifier 500 enables a host to differentiate the logic circuitry package 402 (FIG. 4) from other logic circuitry packages. In some examples, each logic circuit identifier 500 may be unique, i.e., different for different logic circuitry packages. In instances where identifiers 500 are copied by unauthorized third parties, the logic circuit identifier 500 need not be universally unique because two or more instances of the same identifier 500 could exist.

The pairing base key(s) 502 may be used to derive a session key for a pairing session, during which a pairing sequence may be performed. A logic circuit (e.g., 404 of FIG. 4) may cryptographically authenticate pairing commands within a pairing session with a cryptographic authentication algorithm using a session key derived from the pairing base key 502. The cryptographic authentication algorithm may be a symmetric key algorithm and the pairing base key(s) 502 may be symmetric base key(s). The pairing base key identifier(s) 504 correspond to the pairing base key(s) 502, respectively, for the host to specify the key to use for a pairing session.

In some examples, the memory arrangement 406a stores a plurality of (pairing) base keys 502 and a plurality of (pairing) base key identifiers 504, where each base key identifier of the plurality of base key identifiers corresponds to a base key of the plurality of base keys. In this example, as described in more detail below with reference to FIG. 7, a logic circuit may be configured to receive a start session request from a host comprising a selected key identifier, and in response to the selected key identifier matching one of the plurality of key identifiers 504, send the logic circuit identifier 500 to the host. In addition, the logic circuit may be configured to derive a pairing session key based on the pairing base key 502 corresponding to the selected key identifier, for example, upon receipt of a pairing command.

As described in more detail below, shared key field(s) 506 may be used to derive a session key for a nominal session. Each shared key stored in the shared key field(s) 506 may correspond to a specific (e.g., unique) host with which the logic circuit has completed a pairing sequence. The logic circuit is configured to store a shared key in the shared key field(s) 506 corresponding to a shared key of a host in memory arrangement 406a in response to completing a pairing sequence with the host. Accordingly, memory arrangement 406a may not store any shared keys in the shared key field(s) 506 if the logic circuit has not completed a pairing sequence with any host. Communication of specified or requested general use data (e.g., print material level data, color data, and more) between the logic circuit and the host can initiate after successful completion of the pairing sequence. Such communication may occur in what is referred to as a nominal channel, that is, during a nominal session. During the nominal session with the host, communications that involve reading and/or writing general use data may be cryptographically authenticated using a session key derived from the shared key corresponding to the host. As said, the shared key is derived at completion of the pairing sequence. In different examples, the logic circuit can be configured to, after successful completion of the pairing session, communicate general use data without using cryptographic authentication and/or the shared key. In certain instances the logic circuit is configured to allow unauthenticated access or access through a legacy channel, whereby a pairing session does not have to be completed before such unauthenticated access or legacy channel access. The logic circuit may comprise a partition configuration to control unauthenticated access and/or legacy channel access. The partition configuration may set the partitions and/or conditions for the unauthenticated and/or legacy channel access.

FIG. 5B illustrates another example of a memory arrangement 406b. In some examples, memory arrangement 406b may provide memory arrangement 406 of FIG. 4. The memory arrangement 406b stores the logic circuit identifier 500, pairing base key(s) 502, pairing base key identifier(s) 504, and shared key field(s) 506 as previously described and illustrated with reference to FIG. 5A. In addition, memory arrangement 406b stores pairing parameters 508, a global pairing attempt count 516, a session count 518, a global pairing attempt limit 520, and a pairing attempt limit 522. The pairing parameters 508 include host identifier field(s) 510, the shared key field(s) 506 corresponding to respective host identifier field(s) 510, pairing attempt count field(s) 512 corresponding to respective host identifier field(s) 510, and flag field(s) 514 corresponding to respective host identifier field(s) 510.

Pairing parameters 508 may be stored in the form of a table or another suitable data structure, as indicated by the following table partially populated with example data.

PAIRING PARAMETERS TABLE

| | | | Pairing | |
|---|---|---|---|---|
| | Host | Shared | Attempt | |
| Slot | ID | Key | Count | Flag |
| 1 | ID1 | BK1 | 1 | blocked = false |
| 2 | ID2 | BK2 | 2 | blocked = false |
| 3 | ID3 | (empty) | 3 | blocked = false |
| 4 | ID4 | (empty) | 1 | blocked = true |
| 5 | (empty) | (empty) | (empty) | (empty) |
| 6 | (empty) | (empty) | (empty) | (empty) |

The table may include a slot number field indicating the slot number of each record in the table. In this example, six total slots are available indicating that a maximum of six different hosts may be paired with the logic circuit. In other examples, another suitable number of total slots may be available such that less than a maximum of six hosts or more than a maximum of six hosts may be paired with the logic circuit. The logic circuit is configured to populate and/or update the data fields (host ID field, shared key field, pairing attempt count field, and flag field) of each slot, and relate the fields in the same slot to each other. It will be understood that the table is a visual representation and in reality, the data fields can be stored and related to each other in any fashion.

The host identifier field (corresponding to 510 of FIG. 5B) is to store a specific (e.g., unique) identifier corresponding to a host with which the logic circuit is paired or with which the logic circuit has attempted to pair. The shared key field (corresponding to 506 of FIG. 5B) is to store a shared key corresponding to the host identifier once the corresponding host has completed a pairing sequence with the logic circuit to negotiate (e.g., derive) a shared key. The pairing attempt count field (corresponding to 512 of FIG. 5B) is to store a count corresponding to the host identifier indicating the number of times the corresponding host has attempted to pair with the logic circuit. In certain examples, the pairing attempt count can be incremented, decremented, or updated. The logic circuit may compare the pairing attempt count to the pairing attempt limit 522 and refuse to start a pairing session with a host if the pairing attempt count is greater than or equal to the pairing attempt limit. In one example, the pairing attempt limit may be 3, 4, 5, or another suitable number of pairing attempts. In other examples, the pairing attempt count can be decremented to zero. The flag field (corresponding to 514 of FIG. 5B) is to store or pre-store a flag corresponding to the host identifier indicating whether the corresponding host is blocked from starting a pairing or nominal session with the logic circuit or not blocked from starting a pairing or nominal session with the logic circuit.

In the example table, slot one indicates a successful pairing that occurred on the first attempt with a host corresponding to a host identifier ID1 where a shared key BK1 was negotiated. Slot two indicates a successful pairing that occurred on the second attempt with a host corresponding to a host identifier ID2 where a shared key BK2 was negotiated. Slot three indicates three pairing attempts with a host corresponding to host identifier ID3 that were interrupted such that a shared key was not negotiated. Slot four indicates a failed pairing with a host corresponding to host identifier ID4 that occurred on the first attempt, and the host is now blocked as indicated by the corresponding flag. Slots five and six indicate available slots for future pairing attempts with new hosts. In one example, the logic circuit is configured to relate at least two fields of a single slot, for example, at least the host ID and the corresponding shared key.

Thus, in this example, hosts corresponding to host identifiers ID1 and ID2 may start sessions with the logic circuit based on shared keys BK1 and BK2, respectively, without again completing the pairing sequence. The host corresponding to host identifier ID3 may attempt another pairing sequence with the logic circuit if the pairing attempt count is less than a pairing attempt limit (and other checks described below pass). The host corresponding to host identifier ID4 is blocked from attempting another pairing sequence with the logic circuit. With two remaining slots, up to two additional hosts corresponding to host identifiers other than ID1, ID2, ID3, and ID4 may attempt a pairing sequence with the logic circuit to negotiate a shared key.

Global pairing attempt count 516 is a count of the total number of pairing attempts from all hosts combined. The logic circuit may be configured to compare the global pairing attempt count to the global pairing attempt limit 520 and refuse to start a pairing session with a host if the global pairing attempt count is greater than or equal to the global pairing attempt limit. In one example, the global pairing attempt limit may be 8, 10, 12, or another suitable number of pairing attempts. The global pairing attempt count can be an incrementable number. In another example, the global pairing attempt count is incremented by adding values to, or otherwise writing to, fields in a table or list, whereby the global pairing attempt limit may be reached when all fields are filled. In different examples, the global pairing attempt limit can be the highest or lowest of two global pairing attempt limits. For example, global pairing attempt fields in a table may be filled with each attempted pairing session for each different host, whereby the limit may be reached when the lowest of (1) all fields in the table are filled or (2) a separate global pairing attempt count threshold has been reached. Thus, the global pairing attempt limit can be one or both of the count threshold or the number of corresponding fields in a table or list. The global pairing attempt count can be represented by a number or by the fields in the table or list.

The session count 518 is a count of the total number of sessions with all hosts combined. The session count includes pairing sessions and nominal sessions. The logic circuit may be configured to compare the session count to a session limit and refuse to start a pairing or nominal session with any host if the session count is greater than or equal to the session limit. In one example, the session limit may be 500,000 or another suitable number of sessions.

FIG. 6A illustrates an example logic circuit 404a. In some examples, logic circuit 404a may provide logic circuit 404 of FIG. 4. Logic circuit 404a includes pairing instructions 600 and instructions to execute cryptographic functions 602. Logic circuit 404a may be configured to execute pairing instructions 600 within a pairing session to implement a pairing sequence as described in detail below with reference to FIG. 7A. Logic circuit 404a is configured to, within a pairing sequence, execute cryptographic functions 602 in response to input pairing commands to compute results, which are transmitted as part of output pairing commands as also described in detail below with reference to FIG. 7A. In some examples, the cryptographic functions may include responses to challenges that indicate the logic circuit is authentic.

FIG. 6B illustrates an example logic circuit 404b. In some examples, logic circuit 404b may provide logic circuit 404 of FIG. 4. Logic circuit 404b implements a pairing channel 610 and a nominal channel 620. The pairing channel 610 and the nominal channel 620 specify one or more of: different means of determining the host type/instance, the use of corresponding host-specific means of authentication, and the enforcement of the appropriate access to specific commands, command functionalities, attributes, etc. As indicated at 612, the logic circuit 404b is configured to, in the pairing channel 610, use a session key derived from a pairing base key (e.g., 502 of FIG. 5A or 5B). As indicated at 622, the logic circuit 404b is configured to, in the nominal channel 620, use a session key derived from a shared key (e.g., stored in a shared key field 506 of FIG. 5A or 5B).

In one example, logic circuit 404b may receive a start session request from a host. The logic circuit 404b may be configured to, in response to the start session request and in response to not having completed a pairing sequence with the host, communicate with the host through the pairing channel 610. The logic circuit 404b may further be configured to, in response to the start session request and in response to having completed the pairing sequence with the host, communicate with the host through the nominal channel 620.

In another example, the logic circuit 404b may complete a pairing sequence with a host controller. The pairing sequence may include a plurality of pairing commands where each pairing command includes an exchange between the logic circuit 404b and the host controller. The logic circuit 404b may be configured to cryptographically authenticate pairing commands using a session key derived from a pairing base key as indicated at 612. The logic circuit 404b may further be configured to derive a separate shared key different from the pairing base key, at the end of the pairing sequence. The logic circuit 404b may be configured to, e.g., after having successfully completed at least one pairing sequence with the connected host, cryptographically authenticate communications including general use data using a session key derived from the shared key as indicated at 622. Communications that involve general use data may involve read and/or write commands to read and/or write general use data to general use memory. Examples of general use data may include print material level information, color information, and/or more. The logic circuit 404b may complete the pairing sequence in the pairing channel 610, and, after successfully completing the pairing sequence validation and a new start session command, cryptographically authenticate communications in the nominal channel, these communications including general use data cryptographically authenticated using session keys derived from the shared key.

FIG. 7A is a flow diagram 700 illustrating one example of implementing a nominal session 722 (e.g., using a nominal channel 620 of FIG. 6B) or a pairing session 723 (e.g., using a pairing channel 610 of FIG. 6B) between a first logic circuit 702 and a second logic circuit 704 via a host 706, including details of the pairing session 723. The first logic circuit 702 may be a logic circuit 404 of FIG. 4 and be part of a logic circuitry package 402 for a replaceable print apparatus component 400 including an interface 408 to communicate with the host 706. The host 706 may be a print apparatus logic circuit 304 of FIG. 3 as previously described, for example including printer firmware. The second logic circuit 704 may also be a part of the print apparatus, and may communicate with the host 706 through an interface. The second logic circuit 704 may be, or may function as, a microcontroller or secure microcontroller. The combination of the second logic circuit 704 and the host 706 may sometimes be referred to, simply, as “host” or “controller”, while the “second logic circuit” by itself refers to the second logic circuit 704, not the host 706. In one example, the host 706 may be an intermediary between the first logic circuit 702 and the second logic circuit 704 such that all communications between the first logic circuit 702 and the second logic circuit 704 pass through the host 706. In one example, the communications are passed through by firmware running on the host 706, separate from the second logic circuit 704. The text in italics in FIG. 7A indicates commands and/or responses that may be cryptographically authenticated using a session key derived from the pairing base key, while the text not in italics indicates commands and/or responses that may not be cryptographically authenticated using a session key derived from the pairing base key.

At 708, the host 706 transmits a start session request to the first logic circuit 702. In some examples, the start session request may also be referred to as a pairing/nominal start session command, since the same command may be used to start either a pairing session or a nominal session. The start session request includes a host identifier and a key identifier. The host identifier specifically (e.g., uniquely) identifies the host 706 (or the second logic circuit 704), such that different hosts (or second logic circuits) have different host identifiers. The key identifier may include one of the pairing base key identifier(s) 504 of FIG. 5A, which corresponds to a pairing base key 502 of FIG. 5A. At 710, the first logic circuit 702 receives the start session request.

At 712, the first logic circuit 702 may refuse the start session request in response to an invalid start session request. As will be further described below with reference to the following figures, the start session request may be invalid in response to any of the following being true:
If the session count (e.g., 518 of FIG. 5B) is greater than or equal to a session limit;
If the received key identifier does not correspond to a pairing base key (e.g., 502 of FIG. 5B) stored in the memory arrangement (e.g., 406b of FIG. 5B) of the logic circuit;
If the memory arrangement of the logic circuit does not contain an entry (e.g., within pairing parameters 508 of FIG. 5B) corresponding to the host identifier and there are no empty slots (in the Pairing Parameters Table);
If the memory arrangement of the logic circuit does not contain an entry (e.g., within pairing parameters 508 of FIG. 5B) corresponding to the host identifier and the global pairing attempt count (e.g., 516 of FIG. 5B) is greater than or equal to a global pairing attempt limit (e.g., 520 of FIG. 5B);
If the memory arrangement of the logic circuit contains an entry (e.g., within field(s) 510 of FIG. 5B) corresponding to the host identifier and the corresponding flag (e.g., within field(s) 514 of FIG. 5B) indicates the host is blocked;
If the memory arrangement of the logic circuit contains an entry (e.g., within field(s) 510 of FIG. 5B) corresponding to the host identifier, the shared key field (e.g., 506 of FIG. 5B) corresponding to the host identifier is empty, and the pairing attempt count (e.g., within field(s) 512 of FIG. 5B) corresponding to the host identifier is greater than or equal to a pairing attempt limit (e.g., 522 of FIG. 5B); or
If the memory arrangement of the logic circuit contains an entry (e.g., within field(s) 510 of FIG. 5B) corresponding to the host identifier, the shared key field (e.g., 506 of FIG. 5B) corresponding to the host identifier is empty, and the global pairing attempt count (e.g., 516 of FIG. 5B) is greater than or equal to the global pairing attempt limit (e.g., 520 of FIG. 5B).

In response to the start session request being a valid start session request, the first logic circuit 702 increments the session count (e.g., 518 of FIG. 5B), and at 714 the first logic circuit 702 sends the logic circuit identifier (e.g., 500 of FIG. 5B) and the session count stored in the memory arrangement of the first logic circuit to host 706. At 716, the host 706 receives the logic circuit identifier and the session count, and at 717 the host 706 sends a start session command including the logic circuit identifier and the session count to the second logic circuit 704. At 718, the second logic circuit 704 receives the start session command. At 720, the second logic circuit 704 may refuse the start session command in response to an invalid start session command. For example, the second logic circuit 704 may refuse the start session command in response to the received logic circuit identifier being known by the second logic circuit to be illegitimate (e.g., blacklisted). In response to a valid start session command and in response to the second logic circuit 704 having previously paired with the first logic circuit 702 as indicated by the second logic circuit storing a shared key corresponding to the logic circuit identifier, at 722 the second logic circuit 704 may start a nominal session with the first logic circuit 702 deriving a session key from the previously derived shared key. During a nominal session, as will be described in more detail below with reference to FIG. 7B, the host 706 and/or the second logic circuit 704 may communicate with the first logic circuit 702 to operate the replaceable print apparatus component to which the first logic circuit 702 is attached.

In response to a valid start session command and in response to the second logic circuit 704 not storing a shared key corresponding to the logic circuit identifier of the first logic circuit 702, at 724 the second logic circuit may start a pairing session with the first logic circuit 702 and send an initial pairing command (i.e., PAIRING CMD 1) to the host 706. The initial pairing command is received by the host 706 at 726 and may indicate a request to start a pairing session with the second logic circuit 704. At 727, the host 706 passes the initial pairing command to the first logic circuit 702 (without processing or modifying the command). At 728, the first logic circuit 702 receives the initial pairing command indicating the request to start a pairing session. The initial pairing command may also be referred to as an “initial input pairing command” since the command is received by the first logic circuit 702 from the host 706.

At 730, the first logic circuit 702 may refuse the request to start a pairing session with the second logic circuit 704 in response to an invalid initial pairing command. As described further below with reference to the following figures, the initial pairing command may be invalid in response to any of the following being true:
If the global pairing attempt count (e.g., 516 of FIG. 5B) is greater than or equal to a global pairing attempt limit (e.g., 520 of FIG. 5B); or
If the memory arrangement of the logic circuit contains an entry (e.g., within field(s) 510 of FIG. 5B) corresponding to the host identifier and the pairing attempt count (e.g., within field(s) 512 of FIG. 5B) corresponding to the host identifier is greater than or equal to a pairing attempt limit (e.g., 522 of FIG. 5B).

In response to a valid initial input pairing command, if the memory arrangement of the first logic circuit 702 contains an entry (e.g., within field(s) 510 of FIG. 5B) corresponding to the host identifier, the first logic circuit 702 sets the target slot (of the Pairing Parameters Table) to that entry, increments the pairing attempt count (e.g., within field(s) 512 of FIG. 5B), and sets the shared key (e.g., within field(s) 506 of FIG. 5B) to empty for the corresponding host identifier. If the memory arrangement of the first logic circuit 702 does not contain an entry corresponding to the host identifier, the first logic circuit 702 sets a target slot (of the Pairing Parameters Table) to the first empty slot, writes the host identifier to the target slot (e.g., within field(s) 510 of FIG. 5B), and writes the pairing attempt count to 1 to the target slot (e.g., within field(s) 512 of FIG. 5B). The first logic circuit 702 may then increment the global pairing attempt count (e.g., 516 of FIG. 5B) and start the pairing session 723 with the second logic circuit 704 via the host 706. As noted above, in one example the global pairing attempt count can be incremented by filling an additional corresponding global pairing attempt field.

During the pairing session 723, the first logic circuit 702 and the second logic circuit 704 engage in a pairing sequence that includes a plurality of pairing exchanges for granting access to authenticated communications based on a shared key (e.g., using a nominal channel 620 of FIG. 6B). The pairing exchanges are repeated until the pairing sequence is complete. The pairing session, as described further below, includes a plurality of pairing command exchanges (e.g., according to pairing instructions 600 of FIG. 6A) whereby the second logic circuit 704 commands the first logic circuit 702 (via input pairing commands) and the first logic circuit 702 commands the second logic circuit 704 (via output pairing commands). The pairing command exchanges are in two directions. The first logic circuit 702 is configured to perform different cryptographic functions (e.g., 602 of FIG. 6A) in response to different input pairing commands based on parameters of the input pairing commands. For each pairing step, the logic circuit may execute a different cryptographic function. Note that, as mentioned previously, each input and output pairing command may be cryptographically authenticated using a session key derived from the pairing base key, whereby the cryptographic authentication is an additional layer of security in addition to the cryptographic function that is executed in response to the pairing command. The different cryptographic functions comprise different algorithms, while for each pairing command the additional cryptographic authentication layer may involve the same cryptographic algorithm.

During the pairing session 723, the first logic circuit 702 may cryptographically authenticate commands using a symmetric key algorithm and a session key, based on a symmetric base key stored in, or generated by, the first logic circuit 702 and/or the second logic circuit 704 (e.g., based on a pairing base key 502 of FIG. 5B). Also during the pairing session 723, the first logic circuit 702 processes each input pairing command. The first logic circuit 702 may validate each input pairing command and abort the pairing session 723 and write a flag indicating the corresponding host is blocked to the target slot (e.g., within field(s) 514 of FIG. 5B) if any of the following conditions are encountered at any time during the pairing session 723:
Invalid command MAC (Message Authentication Code);
Invalid command code;
Invalid command parameters; or
Command-specific processing error (including command out of sequence).
   The second logic circuit 704 may validate each output pairing command in a similar manner. In addition, the second logic circuit 704 may validate the result of each cryptographic function performed by the first logic circuit in response to each input pairing command.

In response to successfully processing the initial input pairing command, at 732 the first logic circuit 702 sends a second pairing command (i.e., PAIRING CMD 2) to the host 706 (e.g., based on a command code included in the initial input pairing command). The second pairing command may also be referred to as an output pairing command since the first logic circuit 702 outputs the second pairing command to the host 706. At 734, the host 706 receives the second pairing command, and at 735 the host 706 passes the second pairing command to the second logic circuit 704 (without processing or modifying the command). At 736, the second logic circuit 704 receives the second pairing command. The second logic circuit 704 processes the second pairing command (e.g., validates the results included in the second pairing command) and at 738 sends a third pairing command (i.e., PAIRING CMD 3) to the host 706 (e.g., based on a command code included in the second pairing command). At 740, the host 706 receives the third pairing command, and at 741 the host 706 passes the third pairing command to the first logic circuit 702 (without processing or modifying the command). At 742, the first logic circuit 702 receives the third pairing command, processes the third pairing command, and sends a fourth pairing command (not shown) to the host 706.

The pairing sequence continues between the first logic circuit 702 and the second logic circuit 704. At 744, the second logic circuit 704 sends a final input pairing command (i.e., PAIRING CMD N−1) to the host 706, where “N” may be any suitable number (e.g., 6, 8, 10, 12, 14, 16, etc.). At 746, the host receives the final input pairing command, and at 747 the host 706 passes the final input pairing command to the first logic circuit 702 (without processing or modifying the command). At 748, the first logic circuit 702 receives the final input pairing command.

In response to processing the final input pairing command, at 750 the first logic circuit 702 writes a negotiated (e.g., derived) shared key corresponding to the host identifier to the target slot (e.g., within field(s) 506 of FIG. 5B). The first logic circuit 702 may derive (e.g., generate/compute) the shared key based on parameters of the final input pairing command PAIRING CMD N−1. In addition, or instead, the shared key may be generated based on one or more secret values computed by the logic circuit during earlier steps of the pairing sequence. Different algorithms and parameters can be used to derive the shared key during and/or at the end of the pairing sequence. As said already, in certain examples, the shared key is derived at a final pairing stage so that nominal channel communications can be done only after a successful pairing session. How that shared key is exactly derived can be different for different logic circuitry types or logic circuitry generations (e.g., upgraded versions). For example, the logic circuit is configured to derive the shared key from parameters of at least one of the input and/or output pairing commands; at least one of the results of at least one of the performed cryptographic functions in response to the input pairing commands; and/or, at least one different computed secret based on at least one of the pairing commands. At 752, the first logic circuit sends a final output pairing command (i.e., PAIRING CMD N) to the host 706 and terminates the pairing session 723. At 754, the host 706 receives the final output pairing command, and at 755 the host 706 passes the final output pairing command to the second logic circuit 704 (without processing or modifying the command). At 756, the second logic circuit 704 receives the final output pairing command.

In response to processing the final output pairing command, at 757 the second logic circuit 704 stores the logic circuit identifier and a negotiated (e.g., derived) shared key corresponding to the shared key stored by the first logic circuit 702 at 750. It is noted that the final output pairing command does not include the shared key, rather the second logic circuit 704 independently generates the shared key. The second logic circuit 704 then terminates the pairing session 723. In response to completing the pairing sequence, at 758 the second logic circuit 704 sends a success response to the host 706. At 759, the host 706 receives the success response indicating that the pairing sequence has been completed successfully. At this point, both the first logic circuit 702 and the second logic circuit 704 are ready to start subsequent nominal sessions 722 using their mutually negotiated shared key by the host 706 transmitting another start session request to the first logic circuit 702 as indicated at 708 and to the second logic circuit 704 as indicated at 717.

As described above, in each step of the pairing sequence within the pairing session 723, the host 706 receives an output pairing command n returned by the first logic circuit 702 and sends the output pairing command n to the second logic circuit 704, which processes the output pairing command n and returns an input pairing command n+1. This pairing sequence continues until the pairing sequence is completed or until one of the following occurs:
The host 706 interrupts the pairing sequence;
The first logic circuit 702 aborts the pairing sequence (e.g., based on the list of conditions described above); or.
The second logic circuit 704 aborts the pairing sequence.

In summary, each input pairing command received from the second logic circuit 704 via the host 706 by the first logic circuit 702 may instruct the first logic circuit 702 to perform a cryptographic function (e.g., 602 of FIG. 6A). The first logic circuit 702 may be configured to, in response to receiving each input pairing command from the second logic circuit 704, perform the cryptographic function to compute a result and transmit an output pairing command including the result to the second logic circuit 704 via the host 706. Each output pairing command may further include a command code to instruct the second logic circuit 704 to transmit the next input pairing command to instruct the first logic circuit 702 to perform another cryptographic function, which may be different from other cryptographic functions performed in response to other input pairing commands. Each input pairing command may include input pairing parameters to identify parameters of a cryptographic function, and the first logic circuit 702 may execute a corresponding plurality of different cryptographic functions based on the respective input pairing parameters. In certain examples, some input pairing commands may not include input pairing parameters. For example, one or two of the input pairing commands may not include input pairing parameters while all the remaining input pairing commands may include input pairing parameters.

Accordingly, the first logic circuit 702 may transmit a plurality of output pairing commands, each output pairing command including a result computed based on a previously received input pairing command, each output pairing command further comprising a different command code to instruct the second logic circuit 704 to transmit a subsequent input pairing command, until the pairing session 723 has been completed. The first logic circuit 702 may enforce the order of the cryptographic functions and/or pairing commands in the pairing session 723. The first logic circuit 702 may also enforce the number of the cryptographic functions and/or pairing commands in the pairing session 723. In one example, this inhibits access to the corresponding authentication features of the first logic circuit, which in turn may make it more difficult to reverse engineer the first logic circuit.

FIG. 7B is a flow diagram illustrating one example of implementing a nominal session 722 (e.g., using a nominal channel 620 of FIG. 6B) or a pairing session 723 (e.g., using a pairing channel 610 of FIG. 6B) between a first logic circuit 702 and a second logic circuit 704 via a host 706, including details of the nominal session 722. As previously described, the first logic circuit 702 may be a logic circuit 404 of FIG. 4 and be part of a logic circuitry package 402 for a replaceable print apparatus component 400 including an interface 408 to communicate with the host 706. The host 706 may be a print apparatus logic circuit 304 of FIG. 3 as previously described. The second logic circuit 704 may be a part of the print apparatus, which includes host 706, and may communicate with the host 706 through an interface. In some examples, the second logic circuit 704 may be, or may function as, a microcontroller or secure microcontroller. The text in italics in FIG. 7B indicates commands and/or responses that may be cryptographically authenticated using a session key derived from the shared key, while the text not in italics indicates commands and/or responses that may not be cryptographically authenticated using a session key derived from the shared key.

At 762, the host 706 transmits a start session request to the first logic circuit 702. In some examples, the start session request may also be referred to as a pairing/nominal start session command since the same command may be used to start either a pairing session or a nominal session. The start session request at 762 may be substantially the same as the start session request of FIG. 7A at 708. The start session request includes a host identifier and a key identifier. The host identifier specifically (e.g., uniquely) identifies the host 706 (or the second logic circuit 704), such that different hosts (or second logic circuits) have different host identifiers. The key identifier may include one of the pairing base key identifier(s) 504 of FIG. 5A, which corresponds to a pairing base key 502 of FIG. 5A. At 764, the first logic circuit 702 receives the start session request. At 712, the first logic circuit 702 may refuse the start session request in response to an invalid start session request as previously described with reference to FIG. 7A.

In response to the start session request being a valid start session request, the first logic circuit 702 increments the session count (e.g., 518 of FIG. 5B), and at 766 the first logic circuit 702 sends the logic circuit identifier (e.g., 500 of FIG. 5B) and the session count stored in the memory arrangement of the first logic circuit to host 706. At 768, the host 706 receives the logic circuit identifier and the session count and at 769 sends a start session command including the logic circuit identifier and the session count to the second logic circuit 704. At 770, the second logic circuit 704 receives the start session command. At 720, the second logic circuit 704 may refuse the start session command in response to an invalid start session command as previously described with reference to FIG. 7A. In response to a valid start session command and in response to the second logic circuit 704 not storing a shared key corresponding to the logic circuit identifier of the first logic circuit 702, at 723 the second logic circuit 704 may start a pairing session with the first logic circuit 702 as previously described and illustrated with reference to FIG. 7A.

In response to a valid start session command and in response to the second logic circuit 704 having previously paired with the first logic circuit 702 as indicated by the second logic circuit storing a shared key corresponding to the logic circuit identifier, at 772 the second logic circuit 704 may start a nominal session 722 using a session key derived from the previously derived shared key and send a success response to the host 706. At 774, the host 706 receives the success response, and at 775 sends a wrap command including a first command (COMMAND 1) to the second logic circuit 704. The wrap command instructs the second logic circuit 704 to generate a cryptographically authenticated command. The first command may be a read command, a write command, or another suitable command. At 776, the second logic circuit 704 receives the wrap command and generates a cryptographically authenticated first command using the session key for the nominal session 722. At 777, the second logic circuit 704 sends the cryptographically authenticated first command to the host 706.

At 778, the host 706 receives the cryptographically authenticated first command, and at 779 the host 706 sends the cryptographically authenticated first command to the first logic circuit 702. At 780, the first logic circuit 702 receives the cryptographically authenticated first command, verifies the authenticity of the cryptographically authenticated first command, and executes the first command. At 781, the first logic circuit 702 sends a cryptographically authenticated first response (RESPONSE 1) to the host 706 in response to the first command. At 782, the host 706 receives the cryptographically authenticated first response, and at 783 the host 706 sends an unwrap response command including the cryptographically authenticated first response to the second logic circuit 704. The unwrap response command instructs the second logic circuit 704 to decrypt a response. At 784, the second logic circuit 704 receives the unwrap response command and authenticates and decrypts the cryptographically authenticated first response using the session key. At 785, the second logic circuit 704 sends the decrypted first response to the host 706. At 786, the host 706 receives the decrypted first response.

After 786, the host 706 may repeat the process described above from 774 to 786 any suitable number of times to cryptographically authenticate (via second logic circuit 704) and send commands to the first logic circuit 702 and to receive cryptographically authenticated responses from the first logic circuit and to decrypt (via second logic circuit 704) the cryptographically authenticated responses. Once the host 706 has sent all desired commands and received all desired responses from the first logic circuit 702, at 787 the host 706 may send a wrap command including a reset command to the second logic circuit 704. At 788, the second logic circuit 704 receives the wrap command and generates a cryptographically authenticated reset command using the session key. At 789, the second logic circuit 704 sends the cryptographically authenticated reset command to the host 706.

At 790, the host 706 receives the cryptographically authenticated reset command, and at 791 the host 706 sends the cryptographically authenticated reset command to the first logic circuit 702. At 792, the first logic circuit 702 receives the cryptographically authenticated reset command, verifies the authenticity of the cryptographically authenticated reset command, and executes the reset command. At 793, the first logic circuit 702 sends a cryptographically authenticated reset response to the host 706 and ends the nominal session in response to the reset command. At 794, the host 706 receives the cryptographically authenticated reset response, and at 795 the host 706 sends an unwrap response command including the cryptographically authenticated reset response to the second logic circuit 704. At 796, the second logic circuit 704 receives the unwrap response command and authenticates and decrypts the cryptographically authenticated reset response using the session key. At 796, the second logic circuit 704 sends the decrypted reset response to the host 706. At 798, the host 706 receives the decrypted reset response. In other examples, the first logic circuit 702 may end the nominal session in response to receiving an unauthenticated reset command from the host 706. At this point, both the first logic circuit 702 and the second logic circuit 704 may start subsequent nominal sessions 722 using their mutually negotiated shared key by the host 706 transmitting another start session request to the first logic circuit 702 as indicated at 762 and to the second logic circuit 704 as indicated at 769.

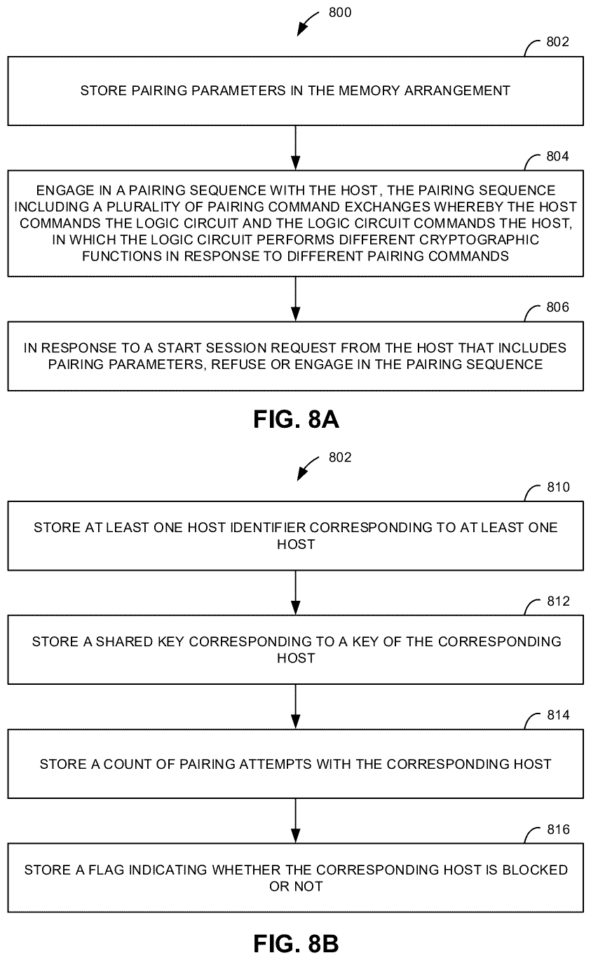

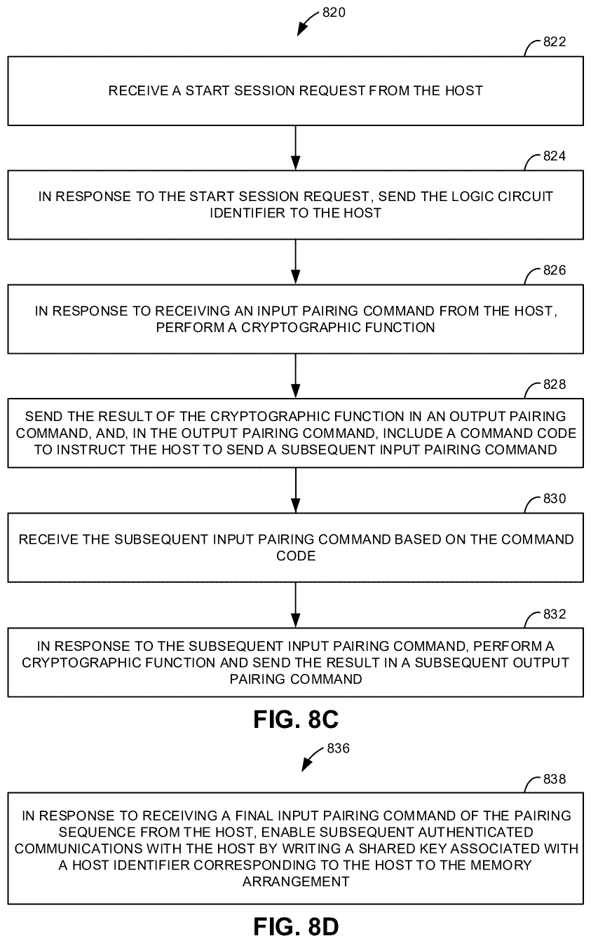

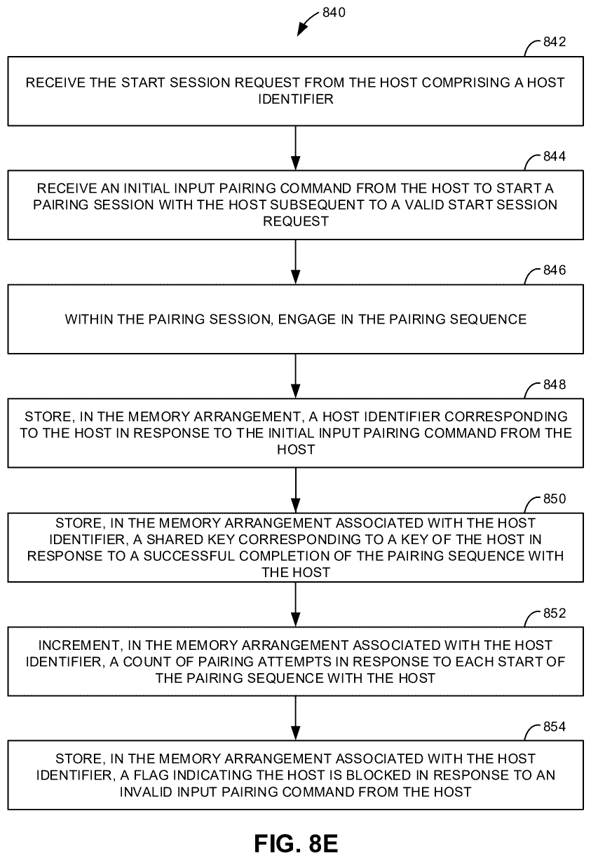

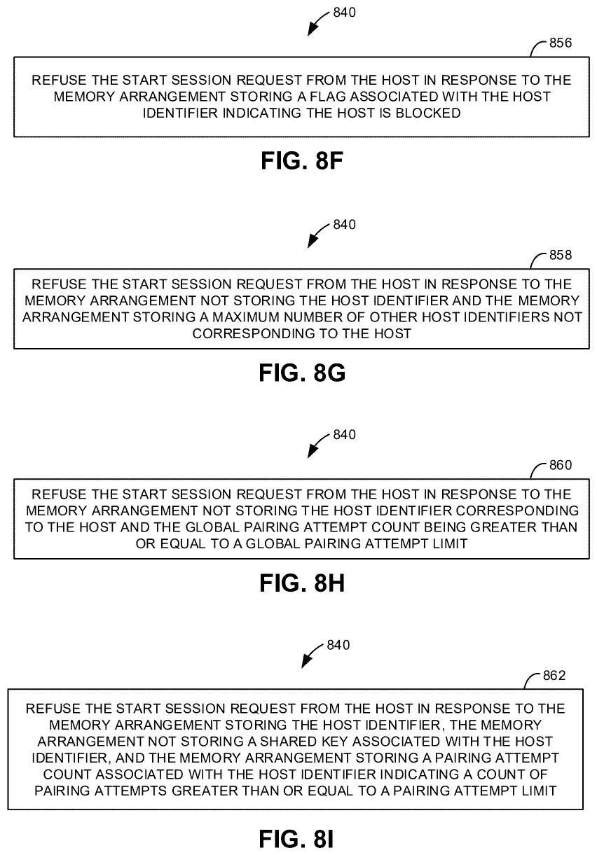

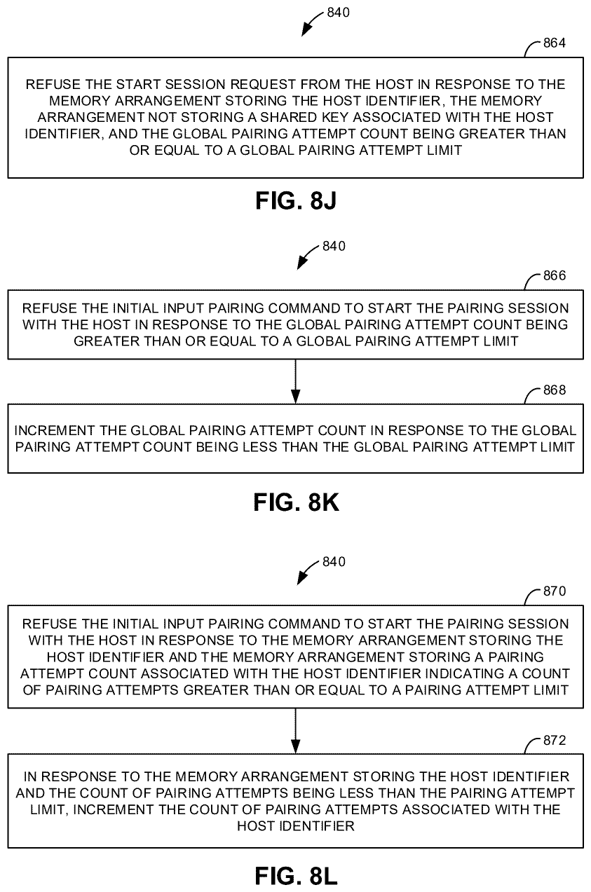

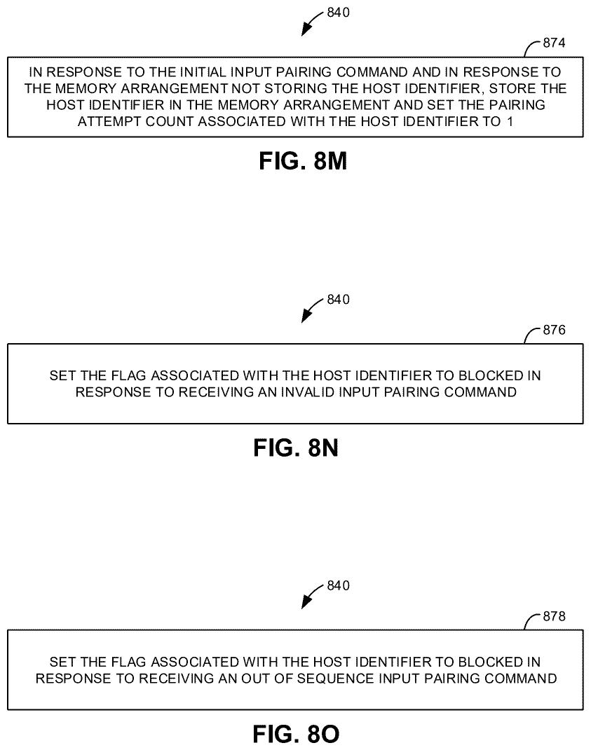

FIGS. 8A-8O are flow diagrams illustrating example methods 800, 820, 836, and 840 that may be carried out by a logic circuit, such as logic circuit 404 of FIG. 4. The logic circuit may be part of a logic circuitry package (e.g., 402 of FIG. 4) for a replaceable print apparatus component (e.g., 400 of FIG. 4) including an interface (e.g., 408 of FIG. 4) to communicate with a print apparatus logic circuit (e.g., 304 of FIG. 3) as previously described. In this example, the memory arrangement (e.g., 406b of FIG. 5B) stores a logic circuit identifier (e.g., 500 of FIG. 5B).

As illustrated by method 800 of FIG. 8A at 802, the logic circuit may be configured to store pairing parameters (e.g., 508 of FIG. 5B) in respective fields of the memory arrangement. At 804, the logic circuit may be configured to engage in a pairing sequence with the host (e.g., the second logic circuit), the pairing sequence including a plurality of pairing command exchanges whereby the host commands the logic circuit and the logic circuit commands the host (e.g., PAIRING CMD 1 to PAIRING CMD N of FIG. 7A), in which the logic circuit performs different cryptographic functions (e.g., 602 of FIG. 6A) in response to different pairing commands. At 806, the logic circuit may be configured to in response to a start session request from the host that includes pairing parameters, refuse (e.g., at 712 or 730 of FIG. 7A) or engage in the pairing sequence (e.g., at 714 or 732 of FIG. 7A).

FIG. 8B illustrates one example of storing pairing parameters in the memory arrangement as indicated at 802 of FIG. 8A. At 810, the logic circuit may be configured to store at least one host identifier (e.g., within field(s) 510 of FIG. 5B) corresponding to at least one host. In one example, the memory arrangement stores a maximum number of host identifiers corresponding to different hosts based on a host identifier limit (e.g., based on the number of slots of the Pairing Parameters Table). At 812, the logic circuit may be configured to store a shared key (e.g., within field(s) 506 of FIG. 5B) corresponding to a (shared) key of the corresponding host. At 814, the logic circuit may be configured to store a count of pairing attempts (e.g., within field(s) 512 of FIG. 5B) with the corresponding host. At 816, the logic circuit may be configured to store a flag (e.g., within field(s) 514 of FIG. 5B) indicating whether the corresponding host is blocked or not.

As illustrated by method 820 of FIG. 8C at 822, the logic circuit may be configured to receive a start session request from the host (e.g., at 710 of FIG. 7A). At 824, the logic circuit may be configured to in response to the start session request, send the logic circuit identifier to the host (e.g., at 714 of FIG. 7A). At 826, the logic circuit may be configured to, in response to receiving an input pairing command from the host (e.g., at 728 or 742, etc. of FIG. 7A), perform a cryptographic function. At 828, the logic circuit may be configured to send the result of the cryptographic function in an output pairing command (e.g., at 732, etc.), and, in the output pairing command, include a command code to instruct the host to send a subsequent input pairing command. At 830, the logic circuit may be configured to receive the subsequent input pairing command based on the command code. At 832, the logic circuit may be configured to in response to the subsequent input pairing command, perform a cryptographic function and send the result in a subsequent output pairing command. This cycle may repeat itself whereby each time a different cryptographic function is performed.

As illustrated by method 836 of FIG. 8D at 838, the logic circuit may be configured to in response to receiving a final input pairing command (e.g., at 748 of FIG. 7A) of the pairing sequence from the host, enable subsequent authenticated communications with the host by writing a shared key (e.g., at 750 of FIG. 7A) associated with a host identifier corresponding to the host to the memory arrangement.

As illustrated by method 840 of FIG. 8E at 842, the logic circuit may be configured to receive the start session request from the host comprising a host identifier. At 844, the logic circuit may be configured to receive an initial input pairing command (e.g., at 728 of FIG. 7A) from the host to start a pairing session (e.g., 723 of FIG. 7A) with the host subsequent to a valid start session request. At 846, the logic circuit may be configured to within the pairing session, engage in the pairing sequence. At 848, the logic circuit may be configured to store, in the memory arrangement, a host identifier (e.g., within field(s) 510 of FIG. 5B) corresponding to the host in response to the initial input pairing command from the host. At 850, the logic circuit may be configured to store, in the memory arrangement associated with the host identifier, a shared key (e.g., within field(s) 506 of FIG. 5B) corresponding to a key of the host in response to a successful completion of the pairing sequence with the host. At 852, the logic circuit may be configured to increment, in the memory arrangement associated with the host identifier, a count of pairing attempts (e.g., within field(s) 512 of FIG. 5B) in response to each start of the pairing sequence with the host. At 854, the logic circuit may be configured to store, in the memory arrangement associated with the host identifier, a flag (e.g., within field(s) 514 of FIG. 5B) indicating the host is blocked in response to an invalid input pairing command from the host.

As illustrated by FIG. 8F at 856, the logic circuit may be further configured to refuse the start session request from the host (e.g., at 712 of FIG. 7A) in response to the memory arrangement storing a flag associated with the host identifier indicating the host is blocked. As illustrated by FIG. 8G at 858, the logic circuit may be further configured to refuse the start session request from the host in response to the memory arrangement not storing the host identifier and the memory arrangement storing a maximum number of other host identifiers not corresponding to the host.

In some examples, the memory arrangement stores a global pairing attempt count (e.g., 516 of FIG. 5B). In this example, as illustrated by FIG. 8H at 860, the logic circuit may be further configured to refuse the start session request from the host in response to the memory arrangement not storing the host identifier corresponding to the host and the global pairing attempt count being greater than or equal to a global pairing attempt limit. As illustrated by FIG. 8I at 862, the logic circuit may be further configured to refuse the start session request from the host in response to the memory arrangement storing the host identifier, the memory arrangement not storing a shared key associated with the host identifier, and the memory arrangement storing a pairing attempt count associated with the host identifier indicating a count of pairing attempts greater than or equal to a pairing attempt limit. As illustrated by FIG. 8J at 864, the logic circuit may be further configured to refuse the start session request from the host in response to the memory arrangement storing the host identifier, the memory arrangement not storing a shared key associated with the host identifier, and the global pairing attempt count being greater than or equal to a global pairing attempt limit. It is again noted that in one example the global pairing attempt count is greater than or equal to a global pairing attempt limit if all global pairing attempt fields are filled, whereby each field represents an increment and the maximum number of fields represents the limit.

As illustrated by FIG. 8K at 866, the logic circuit may be further configured to refuse the initial input pairing command to start the pairing session with the host (e.g., at 730 of FIG. 7A) in response to the global pairing attempt count being greater than or equal to a global pairing attempt limit. At 868, the logic circuit may be further configured to increment the global pairing attempt count in response to the global pairing attempt count being less than the global pairing attempt limit. In some examples, the logic circuit may not increment the global pairing attempt count if the check described below with reference to FIG. 8L fails.

As illustrated by FIG. 8L at 870, the logic circuit may be further configured to refuse the initial input pairing command to start the pairing session with the host in response to the memory arrangement storing the host identifier and the memory arrangement storing a pairing attempt count associated with the host identifier indicating a count of pairing attempts greater than or equal to a pairing attempt limit. At 872, the logic circuit may be further configured to in response to the memory arrangement storing the host identifier and the count of pairing attempts being less than the pairing attempt limit, increment the count of pairing attempts associated with the host identifier. In some examples, the logic circuit may not increment the pairing attempt count if the global pairing attempt check described above with reference to FIG. 8K fails. In one example, if the pairing attempt count is incremented, any (previously derived) shared key corresponding to the host identifier may be cleared from the memory arrangement.

As illustrated by FIG. 8M at 874, the logic circuit may be further configured to in response to the initial input pairing command and in response to the memory arrangement not storing the host identifier, store the host identifier in the memory arrangement and set the pairing attempt count associated with the host identifier to 1. As illustrated by FIG. 8N at 876, the logic circuit may be further configured to set the flag associated with the host identifier to blocked in response to receiving an invalid input pairing command (e.g., invalid command MAC, invalid command code, invalid command parameters). As illustrated by FIG. 8O at 878, the logic circuit may be further configured to set the flag associated with the host identifier to blocked in response to receiving an out of sequence input pairing command.

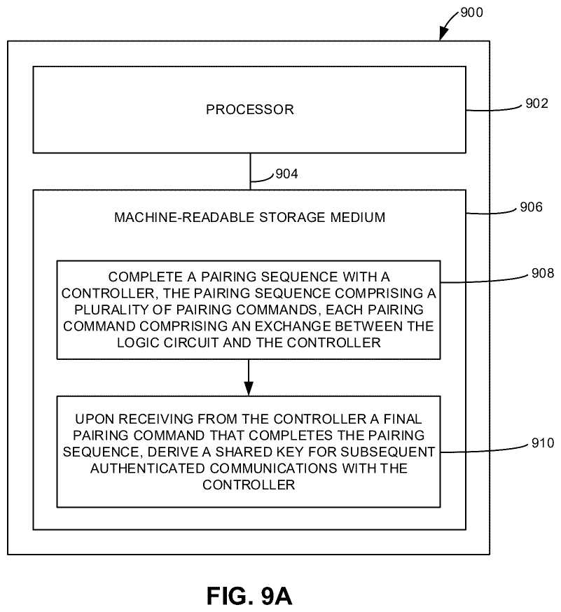

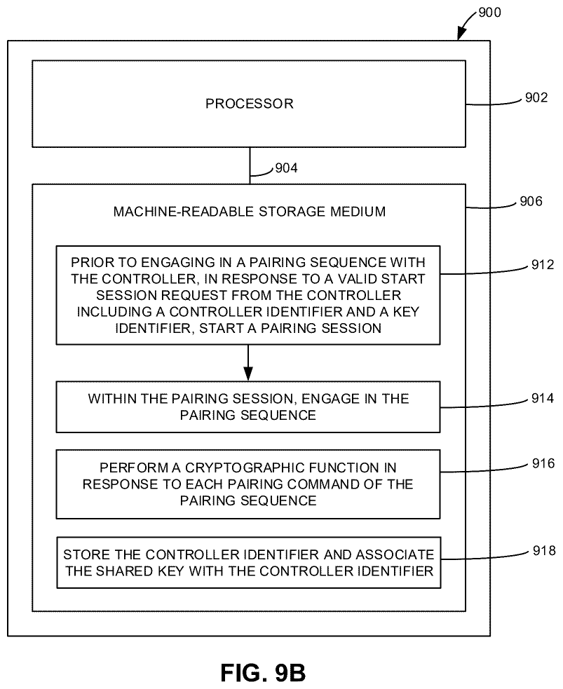

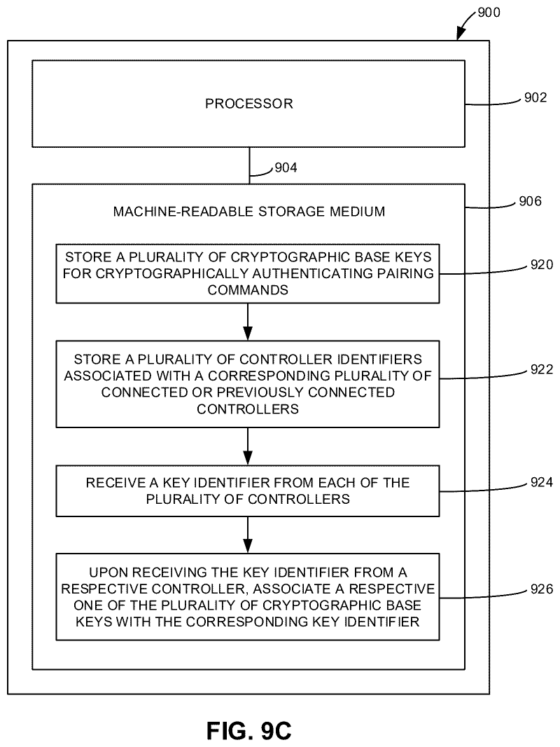

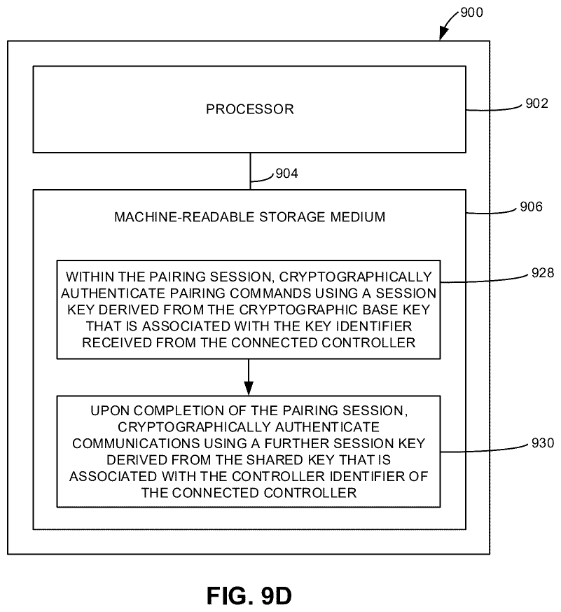

FIGS. 9A-9D are block diagrams illustrating one example of a processing system 900 for pairing a logic circuitry package with a controller. In one example, processing system 900 may be a logic circuitry package (e.g., 402 of FIG. 4) for a replaceable print apparatus component (e.g., 400 of FIG. 4) including an interface (e.g., 408 of FIG. 4) to communicate with a print apparatus logic circuit (e.g., 304 of FIG. 3) as previously described. The processing system 900 may be a secure microcontroller or the like. Processing system 900 includes a processor 902 and a machine-readable storage medium 906. Processor 902 is communicatively coupled to machine-readable storage medium 906 through a communication path 904. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 902 includes one (i.e., a single) central processing unit (CPU) or microprocessor or more than one (i.e., multiple) CPU or microprocessor, and/or other suitable hardware devices for retrieval and execution of instructions stored in machine-readable storage medium 906. Processor 902 may fetch, decode, and execute instructions 908 and 910 to pair a logic circuitry package with a host or controller.

Processor 902 may fetch, decode, and execute instructions 908 to complete a pairing sequence with a controller (e.g., 704 of FIG. 7A), the pairing sequence comprising a plurality of pairing commands (e.g., PAIRING CMD 1 to PAIRING CMD N of FIG. 7A), each pairing command comprising an exchange between the logic circuit and the controller. Processor 902 may fetch, decode, and execute instructions 910 to, upon receiving from the controller a final pairing command (e.g., PAIRING CMD N−1 of FIG. 7A) that completes the pairing sequence, derive a shared key (e.g., at 750 of FIG. 7A) for subsequent authenticated communications with the controller (e.g., via a nominal session 722 of FIG. 7B). In some examples, the pairing sequence may include a controller pairing command (e.g., input pairing command) and a logic circuit pairing command (e.g., output pairing command), each logic circuit pairing command including both a response to a previous controller pairing command and a request for a new controller pairing command, a response to the controller pairing command including an output of a cryptographic function (e.g., 602 of FIG. 6A) performed based on the request.

As illustrated in FIG. 9B, processor 902 may fetch, decode, and execute further instructions 912 to, prior to engaging in a pairing sequence with the controller, in response to a valid start session request from the controller including a controller identifier and a key identifier (e.g., at 710 of FIG. 7A), start a pairing session (e.g., 723 of FIG. 7A). In some examples, processor 902 may fetch, decode, and execute further instructions to, in response to the valid start session request from the controller, at least one of: increment a global pairing attempt count (e.g., 516 of FIG. 5B) and increment a pairing attempt count (e.g., 512 of FIG. 5B) associated to the controller identifier (e.g., 510 of FIG. 5B). Processor 902 may fetch, decode, and execute further instructions 914 to, within the pairing session, engage in the pairing sequence. Processor 902 may fetch, decode, and execute further instructions 916 to perform a cryptographic function (e.g., 602 of FIG. 6A) in response to each (received input) pairing command of the pairing sequence, whereby in one example each cryptographic function of the sequence is different from the others. Processor 902 may fetch, decode, and execute further instructions 918 to store the controller identifier (e.g., within field(s) 510 of FIG. 5B) and (derive and) associate the shared key (e.g., within field(s) 506 of FIG. 5B) with the controller identifier.

As illustrated in FIG. 9C, processor 902 may fetch, decode, and execute further instructions 920 to store a plurality of cryptographic base keys (e.g., 502 of FIG. 5B) for cryptographically authenticating (input and output) pairing commands. The cryptographic authentication may authenticate the output pairing command that includes the result of the cryptographic function of FIGS. 9A and 9B. Processor 902 may fetch, decode, and execute further instructions 922 to store a plurality of controller identifiers (e.g., within field(s) 510 of FIG. 5B) associated with a corresponding plurality of connected or previously connected controllers. Processor 902 may fetch, decode, and execute further instructions 924 to receive a key identifier from each of the plurality of controllers. In one example, block 922 may follow after block 924. Processor 902 may fetch, decode, and execute further instructions 926 to, upon receiving the key identifier from a respective controller, associate a respective one of the plurality of cryptographic base keys with the corresponding key identifier.

As illustrated in FIG. 9D, processor 902 may fetch, decode, and execute further instructions 928 to, within the pairing session, cryptographically authenticate (input and/or output) pairing commands using (e.g., by generating) a session key derived from the cryptographic base key that is associated with the key identifier received from the connected controller. The cryptographic authentication may authenticate the output pairing command that includes the result of the cryptographic function of FIGS. 9A and 9B. Processor 902 may fetch, decode, and execute further instructions 930 to, upon completion of the pairing session, cryptographically authenticate communications using (e.g., by generating) a further session key derived from the shared key that is associated with the controller identifier of the connected controller (e.g., via a nominal session 722 of FIG. 7B).

As an alternative or in addition to retrieving and executing instructions, processor 902 may include one (i.e., a single) electronic circuit or more than one (i.e., multiple) electronic circuits comprising a number of electronic components for performing the functionality of one of the instructions or more than one of the instructions in machine-readable storage medium 906. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 906 is a non-transitory storage medium and may be any suitable electronic, magnetic, optical, or other physical storage device that stores executable instructions. Thus, machine-readable storage medium 906 may be, for example, a random access memory (RAM), an electrically-erasable programmable read-only memory (EEPROM), a storage drive, an optical disc, and the like. Machine-readable storage medium 906 may be disposed within system 900, as illustrated in FIGS. 9A-9D. In this case, the executable instructions may be installed on system 900. Alternatively, machine-readable storage medium 906 may be a portable, external, or remote storage medium that allows system 900 to download the instructions from the portable/external/remote storage medium. In this case, the executable instructions may be part of an installation package.

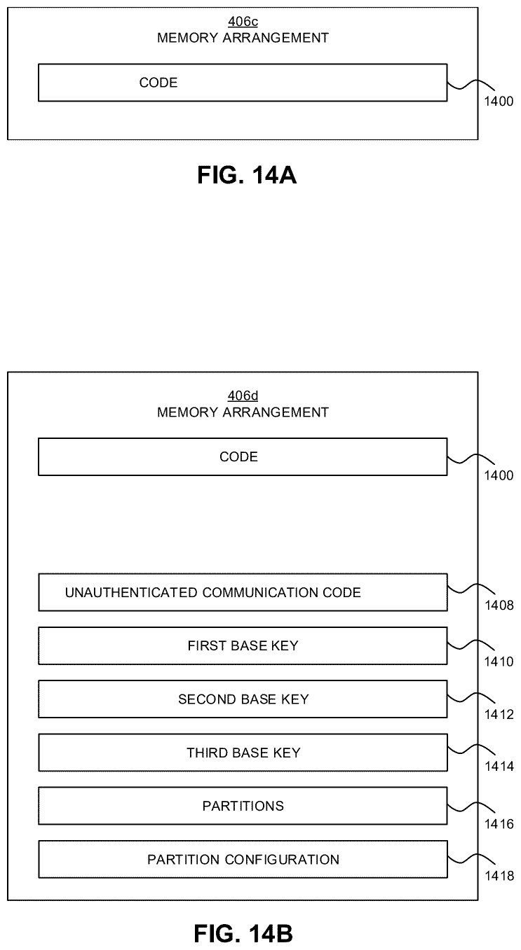

FIG. 10 illustrates another example of a logic circuit 404c. In some examples, logic circuit 404c may provide logic circuit 404 of FIG. 4 or first logic circuit 702 of FIGS. 7A and 7B. Logic circuit 404c implements a pairing channel 610 and a nominal channel 620 as previously described and illustrated with reference to FIG. 6B. In addition, logic circuit 404c implements an admin channel 1000 and a legacy channel 1010. The pairing channel 610, the nominal channel 620, the admin channel 1000, and the legacy channel 1010 specify different means of determining the host type/instance, the use of corresponding host-specific means of authentication, and the enforcement of the appropriate access to specific commands, command functionalities, attributes, etc. within a consumable cartridge. As indicated at 612, the logic circuit 404c is configured to, in the pairing channel 610, derive a session key from a pairing base key (e.g., 502 of FIG. 5A or 5B). As indicated at 622, the logic circuit 404c is configured to, in the nominal channel 620, derive a session key from a shared key (e.g., stored in a shared key field 506 of FIG. 5A or 5B). As indicated at 1002, the logic circuit 404c is configured to, in the admin channel 1000, use a session key received from the host. As indicated at 1012, the logic circuit 404c is configured to, in the legacy channel 1010, derive a session key from a peripheral base key (e.g., third base key 1414 of FIG. 14B).

In one example, logic circuit 404c may receive a pairing/nominal start session request from a host (e.g., at 710 of FIG. 7A or 764 of FIG. 7B). The logic circuit 404c may be configured to, in response to the start session request and in response to not having completed a pairing sequence with the host, communicate with the host through the pairing channel 610. A pairing session 723 as previously described and illustrated with reference to FIG. 7A may be implemented within the pairing channel 610. The logic circuit 404c may further be configured to, in response to the start session request and in response to having completed the pairing sequence with the host, communicate with the host through the nominal channel 620. A nominal session 722 as previously described and illustrated with reference to FIG. 7B may be implemented within the nominal channel 620. It is noted that for the same logic circuit and host, it is intended that for normal use, a single successfully completed pairing session would be sufficient. However, it could exceptionally occur that one or more shared keys are erased from the host and/or logic circuit, for example because the host or logic circuit needs to clear data space in its memory or for other reasons. In such scenario it could occur that a pairing session would be repeated between the host and logic circuit and a new shared key would be generated, even where a previous pairing session was completed between that host and logic circuit. The logic circuit 404c may further be configured to, in response to receiving an admin start session command from the host, communicate with the host through the admin channel 1000. As will be described below with reference to FIG. 11, an admin session 1120 may be implemented within the admin channel 1000. The logic circuit 404c may further be configured to, in response to receiving a legacy start session command from the host, communicate with the host through the legacy channel 1010. As will be described below with reference to FIG. 12, a legacy session 1220 may be implemented within the legacy channel 1010.

The admin channel 1000 may be used to personalize the logic circuit 404c, such as by writing attributes (e.g., logic circuit identifier, partition configuration, and other attributes), cryptographic keys, digital signatures, and other data. The legacy channel 1010 may be used for backward compatibility (e.g., supporting functions of a previous generation of the logic circuit), bench testing, failure analysis, etc. of the logic circuit 404c. For example, the legacy channel 1010 may enable the logic circuit 404c to be used with earlier generations of hosts, for example for testing, manufacturing, printing or printer integrity test purposes.

A pairing session (e.g., 723 of FIG. 7A) may be implemented within the pairing channel 610 but not within the nominal channel 620, the admin channel 1000, or the legacy channel 1010. A nominal session (e.g., 722 of FIG. 7B) may be implemented within the nominal channel 620 but not within the pairing channel 610, the admin channel 1000, or the legacy channel 1010. An admin session (e.g., 1120 of FIG. 11) may be implemented within the admin channel 1000, but not within the pairing channel 610, the nominal channel 620, or the legacy channel 1010. A legacy session (e.g., 1220 of FIG. 12) may be implemented within the legacy channel 1010, but not within the pairing channel 610, the nominal channel 620, or the admin channel 1000. In this way, sensitive functions that are used during initial logic circuit authentication (for a given printer/host) may only be accessible within the pairing channel, while less sensitive functions that are used during printer operation may be accessible within the nominal channel. In addition, sensitive personalization functions that are used during personalization of the logic circuit may only be accessible within the admin channel by an administrative processing system, and less sensitive functions may be accessible within the legacy channel by a limited access processing system.

FIG. 11 is a flow diagram 1100 illustrating one example of implementing an admin session 1120 (e.g., using an admin channel 1000 of FIG. 10) for communication between a first logic circuit 1102, a hardware security module (HSM) 1104, and a host 1106. The first logic circuit 1102 may be a logic circuit 404 of FIG. 4 and be part of a logic circuitry package 402 for a replaceable print apparatus component 400 including an interface 408 to communicate with the host 1106. The host 1106 may be an administrative processing system to personalize the first logic circuit 1102. The HSM 1104 may manage cryptographic keys and perform cryptographic authentication functions (e.g., encryption and decryption functions) for the host 1106, and may communicate with the host 1106 through an interface. In some examples, the HSM 1104 may be, or may function as, a microcontroller or secure microcontroller. The combination of the HSM 1104 and the host 1106 may sometimes be referred to, simply, as “host” or “controller”, while the “HSM” by itself refers to the HSM 1104, not the host 1106. In one example, the host 1106 may be an intermediary between the first logic circuit 1102 and the HSM 1104 such that all communications between the first logic circuit 1102 and the HSM 1104 pass through the host 1106. In one example, the communications are passed through by firmware running on the host 1106, separate from the HSM 1104. The text in italics in FIG. 11 indicates commands and/or responses that may be cryptographically authenticated using an admin session key, while the text not in italics indicates commands and/or responses that are not cryptographically authenticated using an admin session key.

At 1108, the host 1106 transmits a generate admin commands request to the HSM 1104. The generate admin commands request includes a session key identifier and a plurality of commands 1 to N (e.g., COMMAND 1 . . . . COMMAND N), where “N” is any suitable number of commands. The commands may be personalization commands, read commands, write commands, or other suitable commands. In this example, COMMAND N is a reset command used to end the admin session. At 1110, the HSM 1104 receives the generate admin commands request and generates an admin start session command corresponding to the received session key identifier and cryptographically authenticated commands 1 to N using an ephemeral session key. At 1112, the HSM 1104 sends the admin start session command and cryptographically authenticated commands 1 to N to the host 1106. At 1114, the host 1106 receives the start session admin command and cryptographically authenticated commands 1 to N, and at 1116 the host 1106 sends a start session admin command to first logic circuit 1102. The start session admin command includes the session key identifier and an encrypted session key. At 1118, the first logic circuit 1102 receives the start session admin command and starts an admin session 1120 using the received encrypted session key. In this disclosure, admin start session and start session admin are the same; legacy start session and start session legacy are the same; master legacy start session and start session master legacy are the same.

At 1122, in response to starting the admin session 1120, the first logic circuit 1102 sends a cryptographically authenticated success response to the host 1106. At 1124, the host 1106 receives the success response, and at 1126 the host 1106 sends the cryptographically authenticated first command (COMMAND 1) to the first logic circuit 1102. At 1128, the first logic circuit 1102 receives the cryptographically authenticated first command, verifies the authenticity of the cryptographically authenticated first command, and executes the first command. At 1130, the first logic circuit 1102 sends a cryptographically authenticated first response (RESPONSE 1) to the host 1106 in response to the first command. At 1132, the host 1106 receives the cryptographically authenticated first response, and at 1134 the host 1106 sends the cryptographically authenticated second command (COMMAND 2) to the first logic circuit 1102. At 1136, the first logic circuit 1102 receives the cryptographically authenticated second command, verifies the authenticity of the cryptographically authenticated second command, and executes the second command. At 1138, the first logic circuit 1102 sends a cryptographically authenticated second response (RESPONSE 2) to the host 1106 in response to the second command.

After 1140, the host 1106 may repeat the process described above from 1134 to 1140 to send cryptographically authenticated commands 3 to N−1 to the first logic circuit 1102 and to receive cryptographically authenticated responses 3 to N−1 from the first logic circuit. At 1150, the host 1106 sends the cryptographically authenticated last command (COMMAND N, which is a reset command in this example) to the first logic circuit 1102. At 1152, the first logic circuit 1102 receives the cryptographically authenticated reset command, verifies the authenticity of the cryptographically authenticated reset command, and executes the reset command. At 1154, the first logic circuit 1102 sends a cryptographically authenticated reset response (RESPONSE N) to the host 1106 and ends the admin session 1120 in response to the reset command. In other examples, the first logic circuit 1102 may end the admin session 1120 in response to receiving an unauthenticated reset command.

At 1156, the host 1106 receives the cryptographically authenticated reset response. At 1158, the host 1106 sends a verify admin responses request to the HSM 1104. The verify admin responses request includes the start session admin command, the plurality of commands 1 to N (e.g., COMMAND 1 . . . . COMMAND N), and the plurality of cryptographically authenticated responses 1 to N (e.g., RESPONSE 1 . . . . RESPONSE N) received from the first logic circuit 1102. At 1160, the HSM 1104 receives the verify admin responses request and authenticates and decrypts the cryptographically authenticated responses 1 to N using the ephemeral session key. At 1162, the HSM 1104 sends the decrypted responses 1 to N to the host 1106. At 1164, the host 1106 receives the decrypted responses. At this point, the first logic circuit 1102 may start subsequent admin sessions 1120 in response to the host 1106 transmitting another start session admin command to the first logic circuit 1102 as indicated at 1116.

FIG. 12 is a flow diagram 1200 illustrating one example of implementing a legacy session 1220 (e.g., using a legacy channel 1010 of FIG. 10) between a first logic circuit 1202 and a second logic circuit 1204 via a host 1206. The first logic circuit 1202 may be a logic circuit 404 of FIG. 4 and be part of a logic circuitry package 402 for a replaceable print apparatus component 400 including an interface 408 to communicate with the host 1206. The host 1206 may be a limited access processing system (e.g., manufacturing system, bench test system, failure analysis system, etc.). The second logic circuit 1204 may be a part of the limited access processing system, which includes host 1206, and may communicate with the host 1206 through an interface. In some examples, the second logic circuit 1204 may be, or may function as, a microcontroller or secure microcontroller. The combination of the second logic circuit 1204 and the host 1206 may sometimes be referred to, simply, as “host” or “controller”, while the “second logic circuit” by itself refers to the second logic circuit 1204, not the host 1206. In one example, the host 1206 may be an intermediary between the first logic circuit 1202 and the second logic circuit 1204 such that all communications between the first logic circuit 1202 and the second logic circuit 1204 pass through the host 1206. In one example, the communications are passed through by firmware running on the host 1206, separate from the second logic circuit 1204. The text in italics in FIG. 12 indicates commands and/or responses that may be cryptographically authenticated using a session key derived from the peripheral base key, while the text not in italics indicates commands and/or responses that are not cryptographically authenticated using a session key derived from the peripheral base key.

At 1208, the host 1206 sends a start session legacy command to the first logic circuit 1202. The start session legacy command includes a master key identifier and a host diversifier. The master key identifier may correspond to a peripheral base key (e.g., third base key 1414 of FIG. 14B) stored in a memory arrangement of the first logic circuit 1202. At 1210, the first logic circuit 1202 receives the start session legacy command. At 1212, in response to the start session legacy command, the first logic circuit 1202 starts a legacy session 1220 using a session key derived from the peripheral base key corresponding to the received master key identifier and sends a session key identifier to the host 1206. At 1214, the host 1206 receives the session key identifier, and at 1216 the host 1206 sends a start session master legacy command including the session key identifier to the second logic circuit 1204. At 1218, the second logic circuit 1204 receives the start session master legacy command. At 1222, in response to the start session master legacy command, the second logic circuit 1204 starts the legacy session using a session key corresponding to the received session key identifier and sends a success response to the host 1206.

At 1224, the host 1206 receives the success response, and at 1226 the host 1206 sends a generate command MAC request including a read command to the second logic circuit 1204. At 1228, the second logic circuit 1204 receives the generate command MAC request and generates a cryptographically authenticated read command MAC based on the received read command. At 1230, the second logic circuit 1204 sends the cryptographically authenticated read command MAC to the host 1206. At 1232, the host 1206 receives the cryptographically authenticated read command MAC, and at 1234 sends a cryptographically authenticated read command to the first logic circuit 1202. At 1236, the first logic circuit 1202 receives the cryptographically authenticated read command, verifies the authenticity of the cryptographically authenticated read command, and executes the read command. At 1238, the first logic circuit 1202 sends a cryptographically authenticated read response to the host 1206. At 1240, the host 1206 receives the cryptographically authenticated read response, and at 1242 the host 1206 sends a verify response MAC command including a cryptographically authenticated read response MAC based on the received cryptographically authenticated read response to the second logic circuit 1204. At 1244, the second logic circuit 1204 receives the verify response MAC command and verifies the cryptographically authenticated read response MAC. At 1246, in response to a successful validation of the cryptographically authenticated read response MAC, the second logic circuit 1204 sends a success response to the host 1206. At 1248, the host 1206 receives the success response. While the process described above from 1226 to 1248 was described with reference to a read command, in other examples other commands such as write commands or other suitable commands may be used.

After 1248, the host 1206 may repeat the process described above from 1226 to 1248 any suitable number of times to cryptographically authenticate command MACs (via second logic circuit 1204) and send cryptographically authenticated commands to the first logic circuit 1202 and to receive cryptographically authenticated responses from the first logic circuit and to verify cryptographically authenticated response MACs (via second logic circuit 1204). Once the host 1206 has sent all desired commands and received all desired responses to and from the first logic circuit 1202, at 1260 the host 1206 may send an unauthenticated command to the first logic circuit 1202. At 1262, the first logic circuit 1202 receives the unauthenticated command, executes the unauthenticated command, and ends the legacy session 1220 in response to the unauthenticated command. At 1264, the first logic circuit sends a response to the unauthenticated command to the host 1206. At 1266, the host 1206 receives the response. At this point, both the first logic circuit 1202 and the second logic circuit 1204 may start subsequent legacy sessions 1220 in response to the host 1206 transmitting another start session legacy command to the first logic circuit 1202 as indicated at 1208 and transmitting another start session master legacy command to the second logic circuit 1204 as indicated at 1216.

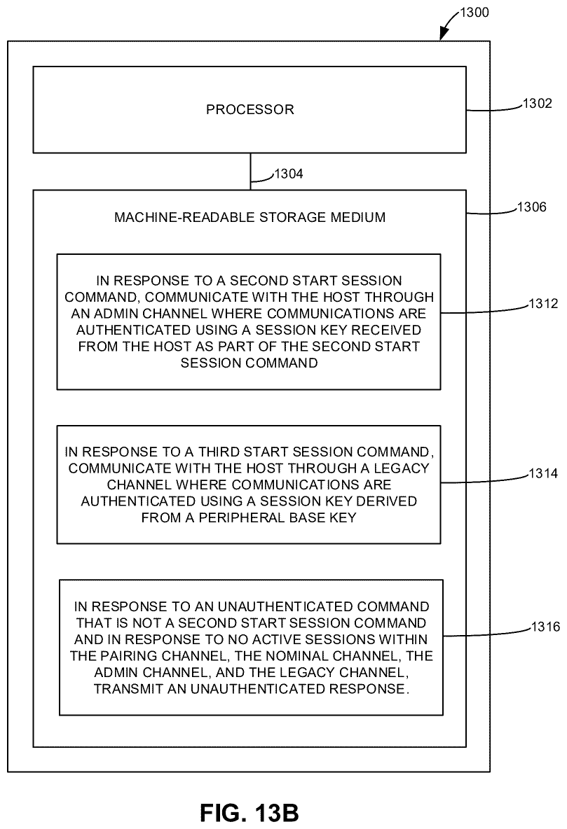

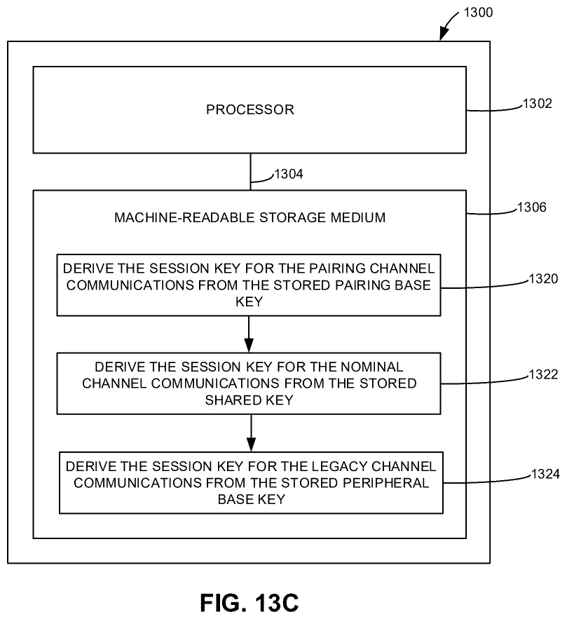

FIGS. 13A-13C are block diagrams illustrating one example of a processing system 1300 for communicating with a host through channels. In one example, processing system 1300 may be a logic circuitry package (e.g., 402 of FIG. 4) for a replaceable print apparatus component (e.g., 400 of FIG. 4) including an interface (e.g., 408 of FIG. 4) to communicate with a print apparatus logic circuit (e.g., 304 of FIG. 3) as previously described. The processing system 1300 may be the same as the processing system 900 of FIGS. 9A-9D. The processing system 1300 may comprise any of the memory arrangements and (first) logic circuits illustrated in, and described with reference to, the FIGS. 4-6, 7A, 7B, 10-12, 14A, and 14B. The processing system 1300 may be a secure microcontroller or the like. Processing system 1300 includes a processor 1302 and a machine-readable storage medium 1306. Processor 1302 is communicatively coupled to machine-readable storage medium 1306 through a communication path 1304. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 1302 includes one (i.e., a single) central processing unit (CPU) or microprocessor or more than one (i.e., multiple) CPU or microprocessor, and/or other suitable hardware devices for retrieval and execution of instructions stored in machine-readable storage medium 1306. Processor 1302 may fetch, decode, and execute instructions 1308 and 1310 to communicate with a host through channels.

Processor 1302 may fetch, decode, and execute instructions 1308 to, in response to a first start session command (e.g., a pairing/nominal start session command at 710 of FIG. 7A) without having previously derived a shared key with the host, communicate with the host through a pairing channel (e.g., 610 of FIG. 6B or 10) where communications are authenticated using a session key (within a pairing session 723 of FIG. 7A) derived from a pairing base key (e.g., 502 of FIG. 5A or 5B), to derive the shared key (e.g., 506 of FIG. 5A or 5B). As explained above, there may be exceptional circumstances where a shared key was previously derived with the host in a pairing session, but the pairing session needs to be repeated to derive a new shared key, for example because the shared key may have been erased. Processor 1302 may fetch, decode, and execute instructions 1310 to, in response to the first start session command and after having derived the shared key, communicate with the host through a nominal channel (e.g., 620 of FIG. 6B or 10) where communications are authenticated using a session key (within a nominal session 722 of FIG. 7B) derived from the shared key. The instructions 1308, 1310 may instruct the processor 1302 to derive a session key from the pairing base key during the pairing session and derive a session key from the shared key during a nominal session.

As illustrated in FIG. 13B, processor 1302 may fetch, decode, and execute further instructions 1312 to, in response to a second start session command (e.g., an admin start session command at 1118 of FIG. 11), communicate with the host through an admin channel (e.g., 1000 of FIG. 10) where communications are authenticated using a session key (within an admin session 1120 of FIG. 11) received from the host as part of the second start session command. Processor 1302 may fetch, decode, and execute further instructions 1314 to, in response to a third start session command (e.g., a legacy start session command at 1210 of FIG. 12), communicate with the host through a legacy channel (e.g., 1010 of FIG. 10) where communications are authenticated using a session key (within a legacy session 1220 of FIG. 12) derived by the processor 1302 from a peripheral base key (e.g., third base key 1414 of FIG. 14B). The instructions 1312, 1314 may instruct the processor 1302 to use a session key received from the host during the admin session and derive a session key from the peripheral base key during the legacy session.

In some examples, the nominal channel, the admin channel, and the legacy channel each enable different functionalities of the logic circuit. The pairing channel, the nominal channel, and the admin channel may each enable different commands of the logic circuit. Pairing commands are enabled and personalization commands are disabled within the pairing channel, personalization commands are enabled and pairing commands are disabled within the admin channel, and pairing commands and personalization commands are disabled within the nominal channel and the legacy channel. The machine-readable storage medium 1306 may further include a plurality of partitions (e.g., 1416 of FIG. 14B) and a partition configuration (e.g., 1418 of FIG. 14B) defining the accessibility of each partition of the plurality of partitions through the nominal channel and the legacy channel. For example the partition configuration may differentiate between, on the one hand, unauthenticated access for the respective partitions, and, on the other hand, nominal and legacy channel access. The partition configuration may define read vs write access to the partitions. The logic circuit may store a further configuration feature that associates keys of the legacy channel with the partitions. In some examples, the logic circuit is configured to not allow access to the plurality of partitions through the pairing channel and allow access to the plurality of partitions through the admin channel.

Processor 1302 may fetch, decode, and execute further instructions 1316 to, in response to receiving an unauthenticated command that is not a second start session command (e.g., not an admin start session command) and in response to no active sessions within the pairing channel, the nominal channel, the admin channel, and the legacy channel, transmit an unauthenticated response.

As illustrated in FIG. 13C, processor 1302 may fetch, decode, and execute further instructions 1320 to derive the session key for the pairing channel communications from the stored pairing base key (e.g., 502 of FIG. 5A or 5B). Processor 1302 may fetch, decode, and execute further instructions 1322 to derive the session key for the nominal channel communications from the stored shared key (e.g., 506 of FIG. 5A or 5B). Processor 1302 may fetch, decode, and execute further instructions 1324 to derive the session key for the legacy channel communications from the stored peripheral base key (e.g., third base key 1414 of FIG. 14B).

As an alternative or in addition to retrieving and executing instructions, processor 1302 may include one (i.e., a single) electronic circuit or more than one (i.e., multiple) electronic circuits comprising a number of electronic components for performing the functionality of one of the instructions or more than one of the instructions in machine-readable storage medium 1306. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 1306 is a non-transitory storage medium and may be any suitable electronic, magnetic, optical, or other physical storage device that stores executable instructions. Thus, machine-readable storage medium 1306 may be, for example, a RAM, an EEPROM, a storage drive, an optical disc, and the like. Machine-readable storage medium 1306 may be disposed within system 1300, as illustrated in FIGS. 13A-13C. In this case, the executable instructions may be installed on system 1300. Alternatively, machine-readable storage medium 1306 may be a portable, external, or remote storage medium that allows system 1300 to download the instructions from the portable/external/remote storage medium. In this case, the executable instructions may be part of an installation package.

FIG. 14A illustrates another example memory arrangement 406c that contains code, included in, and to instruct, any of the logic circuits 404, 404a, 404b, 404c, 702, 1102, 1202, logic circuitry packages 402, and processing systems 900, 1300 of this disclosure. In some examples, memory arrangement 406c may provide for any of memory arrangements 406, 406a, 406b. The memory arrangement 406c stores code 1400 to enable different functionalities of the logic circuit corresponding to each of at least two or at least three different channels. The channels may include at least a pairing and nominal channel, and in an example a legacy channel and/or admin channel, as are described above. The code 1400 instructs the logic circuit to communicate through one of the channels, based on a start session command. The code 1400 may be stored in the form of machine readable (e.g., firmware) instructions and/or parameters that instruct the logic circuit. The code 1400 may determine a configuration of the logic circuit. The stored code 1400 is configured to instruct the logic circuit to enable each of at least two or at least three channels. The code 1400 is configured to enable first functionalities of the logic circuit corresponding to a first channel; enable second functionalities of the logic circuit, different from the first functionalities, corresponding to a second channel; and, enable third functionalities of the logic circuit, different from the first functionalities and the second functionalities, corresponding to a third channel. The code 1400 is configured to instruct the logic circuit to, in response to a respective start session command from the host, initiate the first, second, or third channel, or, reject the start session command. The code may furthermore be configured to enable fourth functionalities of the logic circuit different from the first functionalities, the second functionalities, and the third functionalities, the fourth functionalities corresponding to a fourth channel of the logic circuit, and wherein the logic circuit is further configured to, in response to a start session command from the host, initiate the first, second, third, or fourth channel or reject the start session command. The start session commands associated with the first through fourth channel may include a pairing/nominal start session command, a start session legacy command and/or a start session admin command.

FIG. 14B illustrates another example memory arrangement 406d. In some examples, memory arrangement 406d may provide memory arrangement 406 of FIG. 4. The memory arrangement 406d stores the code 1400 as previously described and illustrated with reference to FIG. 14A. In addition, memory arrangement 406d stores unauthenticated communication code 1408, a first base key 1410, a second base key 1412, a third base key 1414, partitions 1416, and a partition configuration 1418. At least one of the base keys is not pre-stored. Rather, at least one of the base keys may be stored after the base key is derived through a pairing session.

The unauthenticated communication code 1408 enables fifth functionalities (e.g., allowed outside the pairing channel, the nominal channel, the admin channel, and the legacy channel) of the logic circuit different from the first functionalities, the second functionalities, the third functionalities, and the fourth functionalities. Again, this code 1408 may be stored in the form of instructions and/or parameters.

Each of the pairing channel, the nominal channel, the admin channel, and the legacy channel enable different functionalities of the logic circuitry package. In certain embodiments, there may be functionalities that are enabled in multiple channels, all channels, or in none of the channels. For example, a first plurality of functionalities may be enabled in one channel, and a different (second) plurality of functionalities may be enabled in another channel, with no overlap in functionalities between the first and second pluralities, whereby there may be additional functionalities enabled in both these channels outside of said first and second pluralities. Certain examples of logic circuits have at least two or at least three channels. Certain examples are provided with the pairing, nominal and legacy channels.

The first base key 1410 (e.g., a pairing base key) may be used to derive a session key to authenticate communications with a host through the first channel (e.g., pairing channel). The second base key 1412 (e.g., a shared key) may be used to derive a session key to authenticate communications with a host through the second channel (e.g., nominal channel). In one example of memory arrangement 406d, the second base key 1412 is not pre-stored. Rather, the memory arrangement 406d is configured to store the second base key 1412. The third base key 1414 (e.g., a peripheral base key) may be used to derive a session key to authenticate communications with a host through the fourth channel (e.g., legacy channel).

The partitions 1416 (e.g., a plurality of partitions) are portions (e.g., including different address ranges) of the memory arrangement 406d, for example, fields that store digital signatures, print data, consumable level data, page counts, etc. The partition configuration 1418 may define the accessibility of each partition of the plurality of partitions 1416 through each of the first channel (e.g., pairing channel), the second channel (e.g., nominal channel), the third channel (e.g., admin channel), and the fourth channel (e.g., legacy channel), or at least two or three of these channels. The partition configuration 1418 may also define the accessibility of each partition of the plurality of partitions 1416 with the first channel, the second channel, the third channel, and the fourth channel inactive. In some examples, the partition configuration is configured to not allow access to the partitions 1416 through the first channel (e.g., pairing channel) and allow access to all partitions 1416 through the third channel (e.g., admin channel). The partition configuration 1418 may indicate which partitions 1416 are accessible for read and/or write access within the second channel (e.g., nominal channel), the third channel (e.g., admin channel), and the fourth channel (e.g., legacy channel). Thus, the logic circuit is configured so that read and/or write access to the plurality of partitions is different between the pairing channel, the nominal channel, the admin channel, and the legacy channel, or at least two or three of those channels.

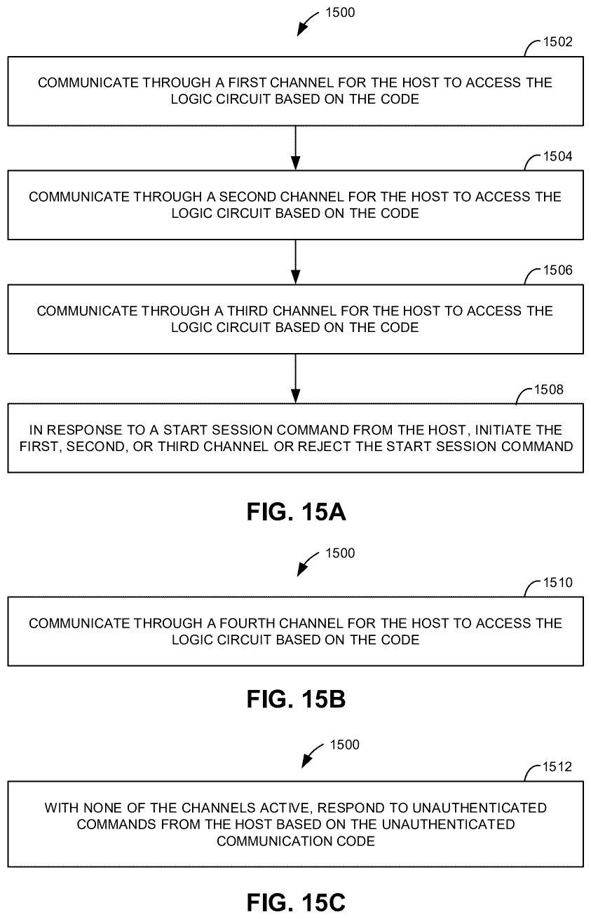

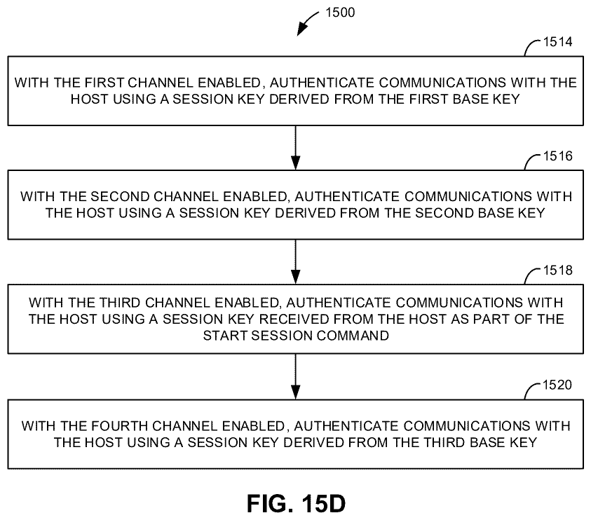

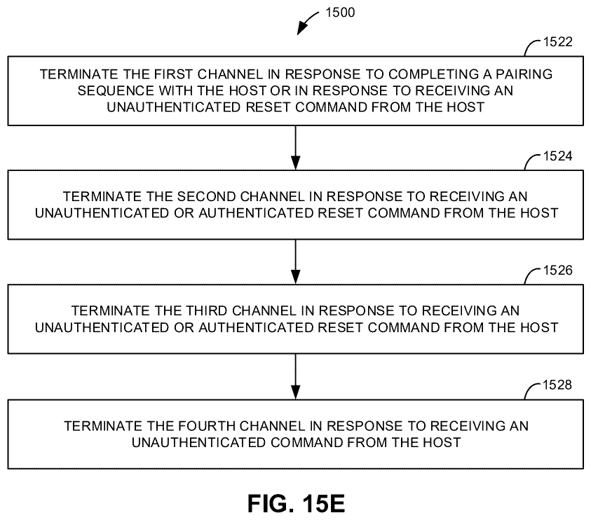

FIGS. 15A-15E are flow diagrams illustrating another example method 1500 that may be carried out by any of the illustrated and described logic circuits, such as logic circuit 404 of FIG. 4. The logic circuit may be part of a logic circuitry package (e.g., 402 of FIG. 4) for a replaceable print apparatus component (e.g., 400 of FIG. 4) including an interface (e.g., 408 of FIG. 4) to communicate with a print apparatus logic circuit (e.g., 304 of FIG. 3) as previously described. In this example, the memory arrangement (e.g., 406c of FIG. 14A) stores code 1400 that is configured to enable first functionalities of the logic circuit corresponding to a first channel; enable second functionalities of the logic circuit, different from the first functionalities, corresponding to a second channel; and, enable third functionalities of the logic circuit, different from the first functionalities and the second functionalities, corresponding to a third channel.

As illustrated by method 1500 of FIG. 15A at 1502, the logic circuit may be configured to communicate through a first channel (e.g., pairing channel 610 of FIG. 10) for the host to access the logic circuit based on the code. At 1504, the logic circuit may be configured to communicate through a second channel (e.g., nominal channel 620 of FIG. 10) for the host to access the logic circuit based on the code. At 1506, the logic circuit may be configured to communicate through a third channel (e.g., admin channel 1000 of FIG. 10) for the host to access the logic circuit based on the code. At 1508, the logic circuit may be configured to, in response to a start session command from the host, initiate the first, second or third channel or reject the start session command.

In some examples, the memory arrangement (e.g., 406d of FIG. 14B) stores code (e.g., 1400 of FIG. 14B) indicating fourth functionalities of the logic circuit different from the first functionalities, the second functionalities, and the third functionalities. As illustrated in FIG. 15B at 1510, the logic circuit may be further configured to communicate through a fourth channel (e.g., legacy channel 1010 of FIG. 10) for the host to access the logic circuit based on the code. In this case, the logic circuit may be further configured to, in response to the start session command from the host, initiate the first, second, third, or fourth channel or reject the start session command.

In some examples, the memory arrangement (e.g., 406d of FIG. 14B) stores unauthenticated communication code (e.g., 1408 of FIG. 14B) indicating fifth functionalities of the logic circuit different from the first functionalities, the second functionalities, the third functionalities, and the fourth functionalities. As illustrated in FIG. 15C at 1512, the logic circuit may be further configured to, with none of the channels active, respond to unauthenticated commands from the host based on the unauthenticated communication code.

In some examples, the memory arrangement (e.g., 406d of FIG. 14B) stores a first base key (e.g., 1410 of FIG. 14B), a second base key (e.g., 1412 of FIG. 14B), and a third base key (e.g., 1414 of FIG. 14B). The second base key need not be pre-stored, but may be stored only after successful pairing completion. As illustrated in FIG. 15D at 1514, the logic circuit may be further configured to, with the first channel enabled, authenticate communications with the host using a session key derived from the first base key. At 1516, the logic circuit may be further configured to, with the second channel enabled, authenticate communications with the host using a session key derived from the second base key. At 1518, the logic circuit may be further configured to, with the third channel enabled, authenticate communications with the host using a session key received from the host as part of the start session command. At 1520, the logic circuit may be further configured to, with the fourth channel enabled, authenticate communications with the host using a session key derived from the third base key.

As illustrated in FIG. 15E at 1522, the logic circuit may be further configured to terminate the first channel in response to completing a pairing sequence (e.g., at 752 of FIG. 7A) with the host or in response to receiving an unauthenticated reset command from the host. At 1524, the logic circuit may be further configured to terminate the second channel in response to receiving an unauthenticated or authenticated reset command (e.g., at 792 of FIG. 7B) from the host. At 1526, the logic circuit may be further configured to terminate the third channel in response to receiving an unauthenticated or authenticated reset command (e.g., at 1152 of FIG. 11) from the host. At 1528, the logic circuit may be further configured to terminate the fourth channel in response to receiving an unauthenticated command (e.g., at 1262 of FIG. 12) from the host.

Examples in the present disclosure described with reference to FIGS. 1-15E can be provided as methods, systems or machine readable instructions, such as any combination of software, hardware, firmware or the like. Such machine readable instructions may be included on a machine readable storage medium (including but not limited to EEPROM, PROM, flash memory, disc storage, CD-ROM, optical storage, etc.) having machine readable program codes therein or thereon.

The present disclosure is described with reference to flow charts and block diagrams of the method, devices, and systems according to examples of the present disclosure. Although the flow diagrams described above show a specific order of execution, the order of execution may differ from that which is depicted. Blocks described in relation to one flow chart may be combined with those of another flow chart. It shall be understood that at least some blocks in the flow charts and block diagrams, as well as combinations thereof can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry may execute the machine readable instructions. Thus, functional modules of the apparatus and devices (for example, logic circuitry and/or controllers) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array, etc. The methods and functional modules may all be performed by a single processor or divided amongst several processors.

Such machine readable instructions may also be stored in a machine readable storage (e.g., a tangible machine readable medium) that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, and “a” or “an” does not exclude a plurality.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A logic circuit comprising:
an interface to communicate with a host;
a processor; and
a memory storing instructions that when executed by the processor cause the processor to:
in response to a first start session command without having previously derived a shared key with the host, communicate with the host through a pairing channel where communications are authenticated using a session key derived from a pairing base key, to derive the shared key; and
in response to the first start session command and after having derived the shared key, communicate with the host through a nominal channel where communications are authenticated using a session key derived from the shared key.

2. The logic circuit of claim 1, wherein the memory stores instructions that when executed by the processor further cause the processor to:
in response to a second start session command, communicate with the host through an admin channel where communications are authenticated using a session key received from the host as part of the second start session command, or
in response to a third start session command, communicate with the host through a legacy channel where communications are authenticated using a session key derived from a peripheral base key.

3. The logic circuit of claim 2, wherein the different channels each enable (i) different functionalities of the logic circuit or (ii) the logic circuit to respond to different commands received from the host.

4. The logic circuit of claim 2, wherein
responding to pairing commands is enabled and responding to personalization commands is disabled within the pairing channel,
responding to personalization commands is enabled and responding to pairing commands is disabled within the admin channel, and
responding to pairing commands and personalization commands is disabled within the nominal channel and the legacy channel.

5. The logic circuit of claim 2, wherein the memory comprises a plurality of partitions and a partition configuration defining the accessibility of each partition of the plurality of partitions through the nominal channel and the legacy channel.

6. The logic circuit of claim 5, wherein the logic circuit is configured to not allow access to the plurality of partitions through the pairing channel and allow access to the plurality of partitions through the admin channel and/or nominal channel.

7. The logic circuit of claim 2, wherein the memory stores the pairing base key and the peripheral base key, and is configured to store the shared key, and
wherein the memory stores instructions that when executed by the processor further cause the processor to:
derive the session key for the pairing channel communications from the stored pairing base key;
derive the session key for the nominal channel communications from the stored shared key; and
derive the session key for the legacy channel communications from the stored peripheral base key.

8. A logic circuitry package comprising:
an interface to communicate with a host;
a logic circuit; and
a memory storing instructions that when executed by the logic circuit cause the logic circuit to:
process a pairing/nominal start session command from the host;
in response to the pairing/nominal start session command, when not having completed a pairing sequence with the host to derive a shared key, communicate with the host through a pairing channel where communications are authenticated using a session key derived from a pairing base key; and
in response to the pairing/nominal start session command, when having stored the shared key associated with the host, communicate with the host through a nominal channel where communications are authenticated using a session key derived from the shared key.

9. The logic circuitry package of claim 8, wherein the memory stores instructions that when executed by the logic circuit further cause the logic circuit to:
process an admin start session command from the host; and
in response to the admin start session command, communicate with the host through an admin channel where communications are authenticated using a session key received from the host as part of the admin start session command.

10. The logic circuitry package of claim 8, wherein the memory stores instructions that when executed by the logic circuit further cause the logic circuit to:
in response to receiving an unauthenticated command while no sessions are active within any of said channels, transmit an unauthenticated response.

11. The logic circuitry package of claim 10, wherein the unauthenticated command is not an admin start session command.

12. The logic circuitry package of claim 8, wherein each of at least two or at least three of the pairing channel, the nominal channel, the admin channel, and the legacy channel enable different functionalities of the logic circuitry package.

13. The logic circuitry package of claim 8, wherein the memory comprises a plurality of partitions and the logic circuit is configured so that read and/or write access to the plurality of partitions is different between the different channels.

14. The logic circuitry package of claim 8, wherein the pairing/nominal start session command includes a host identifier and a first key identifier corresponding to the pairing base key, the admin start session command includes the session key, and/or a legacy start session command includes a second key identifier corresponding to a peripheral base key.

15. The logic circuitry package of claim 8, wherein
the host of the pairing channel and the nominal channel comprises a print apparatus logic circuit,
the host of the admin channel comprises an administrative processing system to personalize the logic circuitry package, and/or
the host of a legacy channel comprises a limited access processing system.

16. A logic circuitry package comprising an interface to communicate with a host, and a logic circuit comprising:
a memory arrangement storing code configured to enable each of at least three channels, the code to
enable first functionalities of the logic circuit corresponding to a first channel,
enable second functionalities of the logic circuit, different from the first functionalities, corresponding to a second channel, and,
enable third functionalities of the logic circuit, different from the first functionalities and the second functionalities, corresponding to a third channel,
wherein the logic circuit is configured to, in response to a start session command from the host, initiate the first, second or third channel or reject the start session command.

17. The logic circuitry package of claim 16, wherein the memory arrangement stores base keys, each base key associated with a respective one of at least two of the channels, and
wherein the logic circuit is configured to:
with a respective channel enabled, authenticate communications with the host using a session key derived from the associated base key.

18. The logic circuitry package of claim 16, wherein the code is furthermore configured to enable fourth functionalities of the logic circuit different from the first functionalities, the second functionalities, and the third functionalities, the fourth functionalities corresponding to a fourth channel of the logic circuit, and
wherein the logic circuit is further configured to, in response to a start session command from the host, initiate the first, second, third, or fourth channel or reject the start session command.

19. The logic circuitry package of claim 18, wherein the memory arrangement is configured to store a first base key, a second base key, and a third base key, and
wherein the logic circuit is configured to:
with the first channel enabled, authenticate communications with the host using a session key derived from the first base key;
with the second channel enabled, authenticate communications with the host using a session key derived from the second base key;
with the third channel enabled, authenticate communications with the host using a session key received from the host as part of the start session command; and
with the fourth channel enabled, authenticate communications with the host using a session key derived from the third base key.

20. The logic circuitry package of claim 18, wherein the logic circuit is configured to:
terminate the first channel in response to completing a pairing sequence with the host or in response to receiving an unauthenticated reset command from the host;
terminate the second channel in response to receiving an unauthenticated or authenticated reset command from the host;
terminate the third channel in response to receiving an unauthenticated or authenticated reset command from the host; and
terminate the fourth channel in response to receiving an unauthenticated command from the host.
